(19) United States
(12) Patent Application Publication
(10) Pub. No.: US 2008/0226361 A1
(43) Pub. Date: Sep. 18, 2008

(54) Image forming apparatus with image adjusting function, image adjusting method and image adjusting program

(75) Inventors: Norio Tomita, Nara-shi (JP); Yoshikazu Harada, Nara-shi (JP); Yoshiteru Kikuchi, Yamatokoriyama-shi (JP); Tetsushi Ito, Nara-shi (JP)

Correspondence Address: Edwards & Angell Palmer & Dodge LLP, P.O. Box 55874, Boston, MA, 02205, US

(73) Assignee: Sharp Kabushiki Kaisha, Osaka (JP)

(21) Appl. No.: 12/074,502

(22) Filed: Mar. 4, 2008

(30) Foreign Application Priority Data
Mar. 7, 2007 (JP) 2007-057657

(51) Int. Cl. G03G 15/01

(52) U.S. Cl. 399/301

(57) ABSTRACT

An image forming apparatus with an image adjusting function using a adjustment patterns transferred on an endless belt including; a calculation unit that obtains, based on the measured positions of the adjustment patterns, a deviation in a rotating direction and/or in a width direction, respectively; and an adjustment unit that adjusts an image to be formed based on each obtained deviation, the adjustment patterns including a first oblique pattern obliquely intersecting with one straight line extending in the width direction of the endless belt in a right front direction and a second oblique pattern obliquely intersecting with the line in a left front direction, the calculation unit obtaining the deviation in the rotating direction from an average of the deviations of the first and second oblique pattern in the rotating direction and obtaining the deviations of the first and second oblique pattern in the width direction, respectively.

### CROSS-REFERENCE TO RELATED APPLICATION

This application is related to Japanese application No. 2007-057657 filed on Mar. 7, 2007 whose priority is claimed under 35 USC §119, the disclosure of which is incorporated by reference in its entirety.

### BACKGROUND OF THE INVENTION

1. Field of the Invention

The present invention relates to an image forming apparatus with an image adjusting function, an image adjusting method and an image adjusting program.

2. Description of the Related Art

An image forming apparatus is known, which is configured to form an image on a photoconductor based on print data received from outside and/or image data obtained by reading a document, and transfer this image on a sheet and output it. In such an image forming apparatus, it is not preferable that a position and a magnification differ for each formed image, due to dispersion of mechanical or electrical characteristics among apparatuses or fluctuation with lapse of time. Particularly, in a color image forming apparatus for outputting the image in a state of superposing the image of a plurality of color components on each other, when the position and the magnification differ for each image of each color component, such a case is liable to be recognized as a color misregistration. Accordingly, the position and the magnification of the image of each color component must be adjusted with accuracy. The color misregistration also occurs by the fluctuation with lapse of time such as a thermal expansion of an image forming unit. Accordingly, an adjustment of only once in a production step or an adjustment with a longer interval of only regular maintenance can not be sufficient. However, when the adjustment of the color misregistration is manually performed, a lot of time and labor are required for such a manual operation. Therefore, the image forming apparatus for adjusting the color misregistration autonomously without requiring manual operation has been introduced on a market, which is configured to form an adjustment pattern when a previously programmed opportunity arrives, and to measure this pattern and to compare it with a reference.

The color image forming apparatus having a plurality of drum type photoconductors (so-called tandem type color image forming apparatus) is known. This is the color image forming apparatus configured to form the image on each photoconductor corresponding to each of the plurality of color components, so that the image thus formed is transferred on a transfer belt and is superposed on each other. In such an apparatus, the adjustment pattern is formed on each photoconductor, the adjustment pattern of each color component is transferred on the transfer belt, and each transferred adjustment pattern is measured to adjust the position where the image of each color component is formed, and adjust the magnification (for example, see Japanese Unexamined Patent Publication No. 2001-109228).

Here, the adjustment of the position and the magnification of the image must be performed in a rotating direction of the transfer belt (sub-scanning direction) and in a width direction (main scanning direction) which is orthogonal to the rotating direction, respectively. According to Japanese Unexamined Patent Publication No. 2001-109228, the adjustment in the sub-scanning direction is performed by using the patterns orthogonally intersecting with each other in the sub-scanning direction, and the adjustment in the main scanning direction is performed by using the patterns obliquely intersecting with each other in the sub-scanning direction.

A pitch fluctuation component caused by an eccentricity of each photoconductor is given as a maximum factor of the color misregistration in the sub-scanning direction. As an ideal way of coping with such a color misregistration, it is preferable to sufficiently reduce the eccentricity of each photoconductor. However, balance between cost and mass productivity must be taken into consideration. Therefore, in order to make the color misregistration inconspicuous even in a case of the same eccentricity, it is proposed that a ratio of a peripheral length of each photoconductor and a peripheral length of the transfer belt is set to an integral number (for example, see Japanese Unexamined Patent Publication No. 07-261499).

From the viewpoint of suppressing the fluctuation of the position and the magnification of the image with a lapse of time, it is preferable to set an adjustment interval short. Particularly, this can be said for the adjustment of the color misregistration in the color image forming apparatus. However, during adjustment, namely, during forming the adjustment pattern and measuring this pattern, original image forming processing cannot be performed. Further, toner is consumed for forming the adjustment pattern. Seen from the viewpoint of a user, this is a factor of lowering of work efficiency and increasing the cost of a consumable material. Particularly, for the user whose use ratio of the monochromatic image is predominantly larger than that of the color image frequent adjustment, the frequent adjustment applied to a color image is possibly not allowed, because the adjustment which is rarely formed, invites lowering of working efficiency and force a user to bear a burden of the increase of cost.

Therefore, a technique capable of performing accurate adjustment by improving a detection accuracy of the color misregistration, thereby expanding the interval of adjustment is desired. Also, the technique capable of shortening the time required for one time adjustment and capable of suppressing the consumption amount of toner by using the adjustment pattern is strongly desired.

### SUMMARY OF THE INVENTION

As a result of earnest study, the inventors of the present invention found that the accuracy of adjustment is lowered, due to a periodic disturbance component that occurs along with driving of the transfer belt and a disturbance component caused by meandering of the transfer belt, and found an adjustment technique capable of suppressing an influence of these disturbances. In addition, when one adjustment pattern has a plurality of adjusting functions, an improved adjustment technique is realized, without increasing the number of patterns to be formed.

In view of the above-described circumstances, the present invention is provided, and an object of the present invention is to provide a technique capable of adjusting the color misregistration with accuracy and capable of suppressing the consumption amount of toner used for adjustment and capable of suppressing the time required for adjustment.

The present invention provides an image forming apparatus with an image adjusting function, including: a photoconductor having a peripheral surface; an image forming unit for forming an image on the peripheral surface and capable of forming a plurality of adjustment patterns on the peripheral surface; an endless belt to which each adjustment pattern is transferred from the peripheral surface and which rotates in a prescribed direction in contact with the peripheral surface; a measurement unit that measures a position of each transferred adjustment pattern on the endless belt; a calculation unit that compares each measured position with a previously defined reference position, and obtains a deviation in a rotating direction and/or in a width direction orthogonal thereto of the endless belt, respectively; and an adjustment unit that adjusts a position and/or a magnification of an image to be formed on the peripheral surface by the image forming unit based on each obtained deviation, the adjustment patterns including a first oblique pattern intersecting with one straight line extending in the width direction on one end side of the endless belt and a second oblique pattern intersecting with the straight line on the other end side, with the first oblique pattern obliquely intersecting with the straight line in a right front direction and the second oblique pattern obliquely intersecting with the straight line in a left front direction, the calculation unit obtaining the deviation in the rotating direction from an average of the deviation of the first oblique pattern in the rotating direction and the deviation of the second oblique pattern in the rotating direction and obtaining the deviations in the width direction from the deviations of the first oblique pattern in the width direction and from the deviations of the second oblique pattern in the width direction, respectively.

In addition, from the different aspect, the present invention provides an image adjusting method, including steps of: forming a plurality of adjustment patterns on a peripheral surface of a photoconductor disposed in an image forming apparatus and having a peripheral surface, and transferring each adjustment pattern to a surface of an endless belt rotating in a prescribed direction in contact with the photoconductor; measuring a position of each transferred adjustment pattern on the endless belt; comparing each measured position with a previously defined reference position for calculation to obtain a deviation in a rotating direction and/or in a width direction orthogonal thereto of the endless belt, respectively; and adjusting a position and/or a magnification of an image to be formed on the peripheral surface by an image forming unit based on each obtained deviation, the adjustment patterns including a first oblique pattern intersecting with one straight line extending in the width direction on one end side of the endless belt and a second oblique pattern intersecting with the straight line on the other end side, with the first oblique pattern obliquely intersecting with the straight line in a right front direction and the second oblique pattern obliquely intersecting with the straight line in a left front direction, the calculation step including: obtaining the deviation in the rotating direction from an average of the deviation of the first oblique pattern in the rotating direction and the deviation of the second oblique pattern in the rotating direction, and obtaining the deviations in the width direction from the deviations of the first oblique pattern in the width direction and from the deviations of the second oblique pattern in the width direction, respectively.

Further, from the different aspect, the present invention provides an image adjusting program causing a computer to execute the processing of: forming a plurality of adjustment patterns on a peripheral surface of a photoconductor disposed in an image forming apparatus and having a peripheral surface, and transferring each adjustment pattern to a surface of an endless belt rotating in a prescribed direction in contact with the photoconductor; measuring a position of each transferred adjustment pattern on the endless belt; comparing each measured position with a previously defined reference position for calculation to obtain a deviation in a rotating direction and/or in a width direction orthogonal thereto of the endless belt, respectively; and adjusting a position and/or a magnification of an image to be formed on the peripheral surface by an image forming unit based on each obtained deviation, the adjustment patterns including a first oblique pattern intersecting with one straight line extending in the width direction on one end side of the endless belt and a second oblique pattern intersecting with the straight line on the other end side, with the first oblique pattern obliquely intersecting with the straight line in a right front direction and the second oblique pattern obliquely intersecting with the straight line in a left front direction, the calculation processing including: obtaining the deviation in the rotating direction from an average of the deviation of the first oblique pattern in the rotating direction and the deviation of the second oblique pattern in the rotating direction, and obtaining the deviations in the width direction from the deviations of the first oblique pattern in the width direction and from the deviations of the second oblique pattern in the width direction, respectively.

### BRIEF DESCRIPTION OF THE DRAWINGS

FIG. 1 is an explanatory view showing an example of an adjustment pattern formed on an intermediate transfer belt 30 according to an embodiment of the present invention;

FIG. 2 is an explanatory view showing a structure of an image forming apparatus according to an embodiment of the present invention;

FIG. 3 is an explanatory view schematically showing a mechanical structure of an essential part of the image forming apparatus of the present invention;

FIG. 4 is a block diagram showing an electrical structure of the essential part of the image forming apparatus of the present invention;

FIGS. 5A and 5B are explanatory views showing an example of a detection timing of a reference clock and an adjustment pattern according to an embodiment of the present invention;

FIG. 6 is an explanatory view showing a condition in which a periodic disturbance component is removed by calculating a sum of the deviation of adjustment pattern groups 72Kf and 73Kf according to an embodiment of the present invention;

FIG. 7 is an explanatory view showing a condition in which a meandering component of FIG. 6 is suppressed;

FIG. 8 is an explanatory view showing a condition in which the periodic disturbance component is removed by calculating the difference of the deviation of the adjustment pattern groups 72Kf and 73Kf in an embodiment of the present invention;

FIG. 9 is an explanatory view showing a condition in which the meandering component of FIG. 8 is further suppressed;

FIGS. 10A to 10C are explanatory views showing influences of patterns Pf and Pr on a detection position, when an intermediate transfer belt 30 meanders in an embodiment of the present invention;

FIG. 11 is an explanatory view showing to simplify only a part related to the adjustment of a sub-scanning DC component of cyan out of the adjustment patterns of FIG. 1;

FIG. 12 is an explanatory view showing to simplify a part related to the adjustment in a main scanning direction out of the adjustment patterns of FIG. 1;

FIG. 13 is a flowchart showing a procedure of an entire body of determining an adjustment amount of each element of a color misregistration in an embodiment of the present invention;

FIG. 14 is a flowchart showing a calculation procedure of a sub-scanning AC component in an embodiment of the present invention, citing black as an example;

FIG. 15 is a flowchart showing the procedure for obtaining the deviation of the sub-scanning DC component in an embodiment of the present invention, citing cyan as an example;

FIG. 16 is a flowchart showing the procedure for obtaining the deviation on a main scanning starting end side in an embodiment of the present invention, citing cyan as an example;

FIG. 17 is a flowchart showing the procedure for obtaining the deviation on a main scanning terminate end side in an embodiment of the present invention, citing cyan as an example;

FIG. 18 is an explanatory view showing a photoconductor drum 10 of the image forming apparatus according to an embodiment of the present invention and a drive mechanism of a photoconductor drive motor for driving the same;

FIGS. 19A and 19B are waveform charts, showing a peripheral speed fluctuation component and a pitch fluctuation component of a photoconductor in each case according to an embodiment of the present invention;

FIG. 20 is an explanatory view showing a condition in which a toner pattern for adjustment is formed on a photoconductor drum according to an embodiment of the present invention;

FIGS. 21A and 21B are explanatory views for explaining a relation between a reference rotation angle and a reference phase regarding FIG. 20;

FIG. 22 is an explanatory view showing the peripheral speed fluctuation component according to an embodiment of the present invention, with a rotating phase of the photoconductor adjusted;

FIG. 23 is an explanatory view showing a condition in which a stop position is adjusted so as to stop a Y photoconductor drum, with rotating phases of M and C photoconductor drums aligned by a controlling unit according to an embodiment of the present invention; and

FIG. 24 is an explanatory view showing a condition in which the rotating phase is adjusted by the controlling unit according to an embodiment of the present invention.

### DETAILED DESCRIPTION OF THE PREFERRED EMBODIMENTS

One of the technical features of the present invention is summarized in a shape of an adjustment pattern mainly formed by an image forming unit and a calculation method of a deviation by a calculation unit. More specifically, in the image forming apparatus of the present invention, the adjustment pattern includes a first oblique pattern intersecting with one straight line extending in the width direction on one end side of the transfer belt, and a second oblique pattern intersecting with the strait line on the other end side, and the first oblique pattern obliquely intersects with the straight line in a right front direction, and the second oblique pattern obliquely intersects with the straight line in a left front direction. The calculation unit obtains the deviation in the rotating direction by an average of the deviation in the rotating direction of the first oblique pattern and the rotating direction of the second oblique pattern, and determines the deviation in the width direction from the first oblique pattern and the second oblique pattern, thus making it possible to suppress an influence of meandering of the transfer belt on a detection of the deviation. Namely, two measurement points for measuring the deviation of the first and second oblique patterns are arranged at prescribed positions in the width direction. However, when the transfer belt is deviated in the width direction, the timing when one of the patterns passes through the corresponding measurement point is delayed from a reference, and the timing when the other pattern passes through the corresponding measurement point is advanced from the reference. The deviation in the rotating direction is obtained by averaging the deviations of two patterns, and therefore the influence of meandering is suppressed. By utilizing this property, the first and second oblique patterns can be used for accurately obtaining the deviation in the sub-scanning direction, and particularly can be used for the detection of the pitch fluctuation in the sub-scanning direction that occurs along with an eccentricity of a photoconductor. In addition, the first and second oblique patterns can also be used for obtaining the deviation in a main scanning direction, and therefore the total number of the adjustment patterns can be reduced.

In this invention, the photoconductor is provided for forming an image by an electrophotographic process, corresponding to the photoconductor drum as will be described later in an embodiment. The image forming unit is provided for forming the image on a peripheral surface of the photoconductor by the electrophotographic process, and in the embodiment as will be described later, the image forming unit is constituted of a charging roller, a developing unit, and a cleaning unit, etc. The endless belt is a member on which the image of each color component is transferred and superposed, and an intermediate transfer belt corresponds thereto in the embodiment as will be described later. A sensor (photo-sensor in the embodiment as will be described later) for detecting the position of the image transferred on the endless belt and a CPU (a controlling unit in the embodiment as will be described later) for processing its signal are provided so as to correspond to a measurement unit. In addition, functions of the calculation unit and the adjustment unit can also be realized by the CPU (controlling unit in the embodiment as will be described later).

Preferred embodiments of the present invention will be explained hereunder.

In the present invention, the first oblique pattern and the second oblique pattern may obliquely intersect with the straight line at a same angle. In this way, values of a disturbance component influencing a measurement result of the first oblique pattern and the disturbance component influencing the measurement result of the second oblique pattern generated by meandering become the same values, as absolute values. Therefore, by averaging both values, the disturbance component is minimized.

Further, the first oblique pattern and the second oblique pattern may obliquely intersect with the straight line at approximately 45 degrees.

In addition, the aforementioned adjustment pattern may include a first oblique pattern group in which a plurality of patterns are arranged on one end side of the endless belt, and a second oblique pattern group in which patterns corresponding to each pattern of the first oblique pattern group are arranged on the other end side. The first oblique pattern group may be formed of the first oblique pattern and a pattern parallel thereto arranged in the rotating direction, and the second oblique pattern group may be formed of the second oblique pattern and a pattern parallel thereto arranged in the rotating direction. The calculation unit may obtain a plurality of average deviations in the rotating direction, each average deviation being obtained from an average of the deviations of two patterns corresponding to each other in the width direction, out of the patterns in the first oblique pattern group and the patterns in the second oblique pattern group, and based on a change of each average deviation, may extract a phase of the periodic fluctuation component corresponding to a peripheral length of the photoconductor. Here, lengths of the first and second oblique pattern groups in the rotating direction are preferably almost equal to the peripheral length of the photoconductor. In other words, even when the photoconductor is eccentric, the first and second oblique pattern groups are preferably have the lengths capable of suppressing the influence of eccentricity by averaging the deviation of each pattern of the pattern group. In this way, the periodic fluctuation component in the rotating direction can be obtained by obtaining the average deviation, while suppressing the influence of meandering.

Still further, it may be so configured that the adjustment patterns includes a first oblique pattern group formed of the first oblique pattern and one or more patterns parallel thereto arranged in the rotating direction; and that the calculation unit obtains the deviations of the patterns of the first oblique pattern group in the width direction, respectively, and averages the obtained deviations to set it as the deviation in the width direction on a main scanning starting end side. In this way, by averaging the deviation of each pattern in the rotating direction, a steady-state deviation in the width direction on the starting end side in the main scanning direction can be accurately obtained.

In addition it may be so configured that the adjustment patterns include a second oblique pattern group formed of the second oblique pattern and one or more patterns parallel thereto arranged in the rotating direction; and that the calculation unit obtains the deviations of the patterns of the second oblique pattern group in the width direction, respectively, and averages the obtained deviations to set it as the deviation in the width direction on a main scanning terminating end side. In this way, by averaging the deviation of each pattern in the rotating direction, the steady-state deviation in the width direction on the terminate end side in the main scanning direction can be accurately obtained.

The image forming unit may have an input section for acquiring from the outside an image data representing the image to be formed and an adjustment patterns storage section for storing the predetermined pattern data representing the adjustment patterns.

Still further, it may be so configured that the image forming apparatus forms a color image made of a plurality of color components, the photoconductor is disposed for each color component, respectively; the endless belt is brought into contact with each photoconductor. Then, the measurement unit may measure the adjustment pattern of each color component; and the calculation unit recognizes a position of the adjustment pattern of a previously defined color component (reference color) as a reference and compares it with a position of the adjustment pattern of another color to obtain the deviation of a color component of a color other than the reference color. In this way, it is possible to obtain an adjustment amount of the position to form the color component of other color, with one color as a reference.

Further, it may be so configured that the adjustment patterns further include a first horizontal pattern group formed of a plurality of patterns arranged in the rotating direction, the plurality of patterns positioned on a main scanning starting end side, which is one end side of the endless belt in the width direction, and extending in the width direction; the image forming unit forms each pattern of the first oblique pattern group and each pattern of the first horizontal pattern group corresponding thereto at a prescribed interval in the rotating direction; the adjustment unit extracts a phase of a fluctuation component corresponding to a rotation period of the photoconductor based on the deviation of each pattern of the first oblique pattern group and the deviation of each pattern of the first horizontal pattern group; and the prescribed interval is set so that phases of previously estimated periodic disturbance components of the first oblique pattern group and the first horizontal pattern group are opposite to each other.

In addition, it may be so configured that the adjustment patterns further include a second horizontal pattern group formed of a plurality of patterns arranged in the rotating direction, the plurality of patterns positioned on a main scanning end side, which is another end side of the endless belt in the width direction, and extending in the width direction; the image forming unit forms each pattern of the second oblique pattern group and each pattern of the second horizontal pattern group corresponding thereto at a prescribed interval in the rotating direction; the adjustment unit extracts a phase of a fluctuation component corresponding to a rotation period of the photoconductor based on the deviation of each pattern of the second oblique pattern group and the deviation of each pattern of the second horizontal pattern group; and the prescribed interval is set so that phases of previously estimated periodic disturbance components of the second oblique pattern group and the second horizontal pattern group are opposite to each other.

Also, it may be so configured that a drive roller for driving the endless belt is further provided, and that the prescribed interval is set to be m times a peripheral length of the photoconductor and (n+½) times a peripheral length of the drive roller, when m and n are set to be integral numbers. In this way, the fluctuation component corresponding to the rotation period of the photoconductor can be obtained while suppressing the influence of the disturbance component which is equal to the rotation period of the drive roller.

Also, it may be so configured that the drive roller for driving the endless belt is further provided, and that the prescribed interval is set to be (m+½) times a peripheral length of the photoconductor and n times a peripheral length of the drive roller, when m and n are set to be integral numbers. In this way, the fluctuation component corresponding to the rotation period of the photoconductor can be obtained while suppressing the influence of the disturbance component which is equal to the rotation period of the drive roller.

A plurality of various preferred embodiments shown here can be combined.

The present invention will be described further in detail hereunder, by using the drawings. Note that the explanation given hereunder is shown as examples in all points and should not be interpreted as limiting this invention.

### (An Overall Mechanical Structure of an Image Forming Apparatus)

At first, a mechanical constitutional example of the image forming apparatus of the present invention will be explained. Particularly, explanation is given for a photoconductor, an image forming unit, an endless belt, and a measurement unit included in the image forming apparatus.

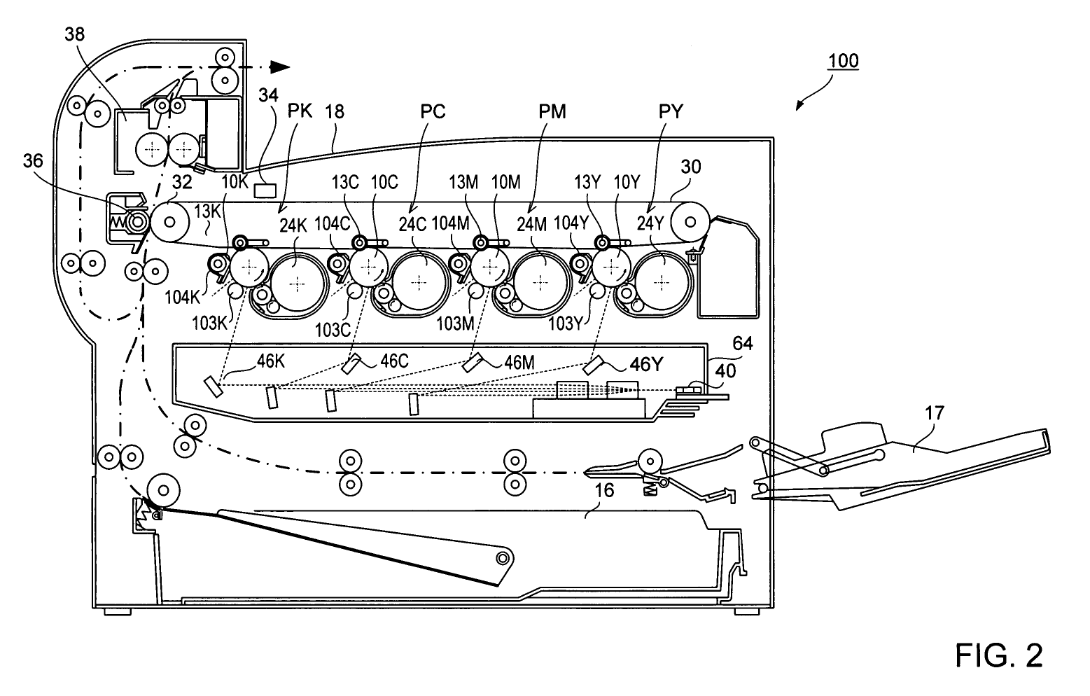

FIG. 2 is an explanatory view showing a structure of the image forming apparatus according to an embodiment of the present invention. An image forming apparatus 100 serves as an electrophotographic type color image forming apparatus for forming a multicolor and monochromatic color images on a recording sheet such as a paper.

The image forming apparatus 100 includes an exposure unit 64, a photoconductor drum 10 (10Y, 10M, 10C, 10K), a developing unit 24 (24Y, 24M, 24C, 24K), a charging roller 103 (103Y, 103M, 103C, 103K), a cleaning unit 104 (104Y, 104M, 104C, 104K), an intermediate transfer belt 30, an intermediate transfer roller (referred to as a transfer roller hereinafter) 13 (13Y, 13M, 13C, 13K), a photo sensor 34, a secondary transfer roller 36, a fusing device 38, a sheet feeding cassette 16, a manual sheet feeding tray 17, and a sheet exit tray 18, etc.

The photoconductor drum 10 corresponds to the photoconductor according to the present invention.

The image forming apparatus of the present invention is constituted of the developing unit 24, the charging roller 103, the cleaning unit 104, etc for each color component.

The intermediate transfer belt 30 corresponds to the endless belt of the present invention.

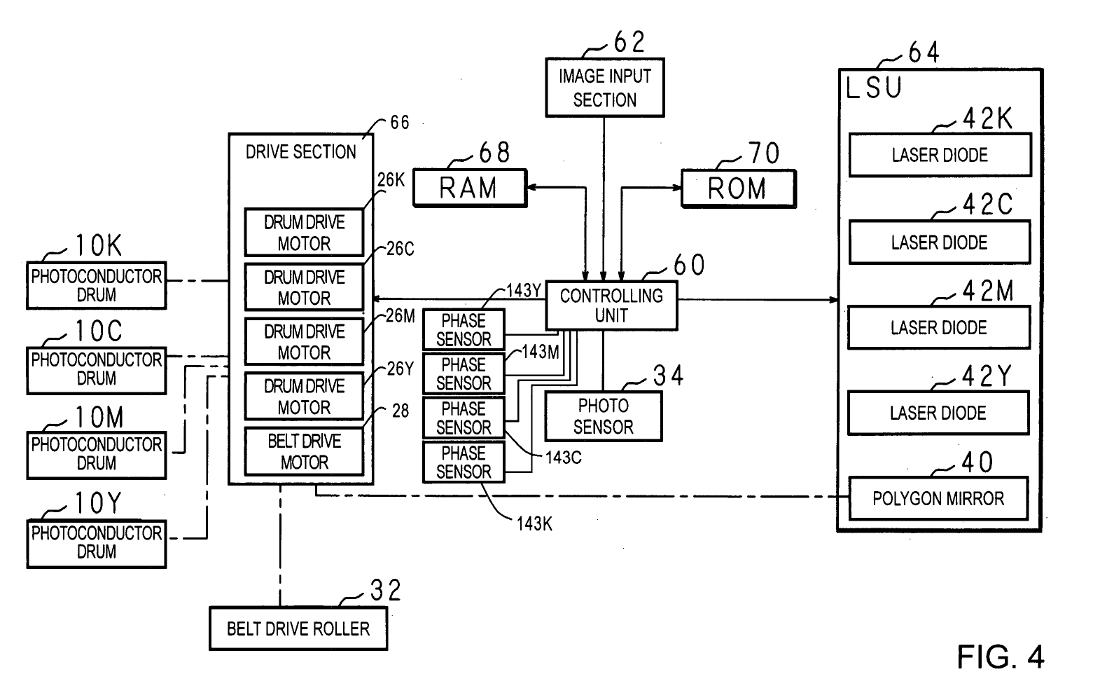

The photo sensor 34 realizes a function of the measurement unit of the present invention, when combined with a controlling unit 60 of FIG. 4 as will be described later.

In addition, the controlling unit 60, an RAM 68, and an ROM 70 shown in FIG. 4 as will be described later realizes functions of the calculation unit and the adjustment unit according to the present invention.

The image forming apparatus 100 performs image formation by using image data corresponding to each color component of four colors added with black (K) to cyan (C), magenta (M), and yellow (Y) of three primary colors of a subtractive color mixture of a color image. Four photoconductor drums 10 (10Y, 10M, 10C, 10K), developing units 24 (24Y, 24M, 24C, 24K), charging rollers 103 (103Y, 103M, 103C, 103K), transfer rollers (13Y, 13M, 13C, 13K), and cleaning units 104 (104Y, 104M, 104C, 104K) are provided according to each color component, and constitute four image forming units PK, PC, PM, PY. The image forming units PK, PC, PM, PY are arranged in a row in a rotating direction (corresponding to a sub-scanning direction) of the intermediate transfer belt 30. Alphabets Y, M, C, and K given to the ending of each designation mark of the aforementioned each part correspond to each color component. Namely, Y corresponds to yellow, M corresponds to magenta, C corresponds to cyan, K corresponds to black, respectively. When the alphabet of the ending is omitted, the explanation therefore is applied to all color components.

The charging roller 103 is a charging unit of a contact system for uniformly charging a surface of the photoconductor drum 10 to a prescribed potential. Instead of the charging roller 103, the charging unit of a contact system using a charging brush or the charging unit of a non-contact system using a charger can be used. The exposure unit (called also LSU or Laser Scanning Unit) 64 includes a laser diode not shown in FIG. 2, a polygon mirror 40, and a reflection mirror 46 (46Y, 46M, 46C, 46K), etc. The laser diode is provided corresponding to each color component, and a laser beam modulated by the image data of each color component of black, cyan, magenta, and yellow is emitted from each laser diode. The surface of the photoconductor drum 10 uniformly charged by the charging roller 103 is respectively irradiated with each laser beam. Thus, an electrostatic latent image according to the image data of each color component is formed on the surface of the photoconductor drum 10. Namely, the electrostatic latent image corresponding to each image data of yellow, magenta, cyan, and black is respectively formed on the photoconductor drums 10Y, 10M, 10C, and 10K.

The developing unit 24 develops the electrostatic latent image formed on each photoconductor drum 10 by the toner corresponding to each color component. As a result, a visualized image (toner image) of each color component is formed on the surface of each photoconductor drum 10. When the monochromatic image is formed, the electrostatic latent image is formed only on the photoconductor drum 10K, and only the toner image of black is formed. When a color image is formed, the electrostatic latent image is respectively formed on the photoconductor drums 10Y, 10M, 10C, and 10K, and the toner image of yellow, magenta, cyan, and black is formed.

The intermediate transfer roller 13 transfers each toner image on the intermediate transfer belt 30 by an action of a transfer voltage applied thereto. The intermediate transfer belt 30 circulates to the side of 13a from the side of the intermediate transfer roller 13d. When the color image is formed, each toner image is superposed on the intermediate transfer belt 30 in an order of yellow, magenta, cyan, and black, with the rotation of the intermediate transfer belt 30. The superposed toner image passes through a part where the secondary transfer roller 36 is disposed. At this time, in synchronization with a passing timing of the toner image, the recording sheet is fed from the sheet feeding cassette 16 or the manual sheet feeding tray 17. The fed recording sheet is transferred between the intermediate transfer belt 30 and the secondary transfer roller 36, and comes in contact with the toner image. The secondary transfer roller 36 transfers the toner image on the recording sheet by an action of the secondary transfer voltage applied thereto. The recording sheet, on which the toner image is transferred, is discharged onto the sheet exit tray 18 through the fusing device 38. The fusing device 38 melts the toner image and fixes it onto the recording sheet when the recording sheet passes therethrough.

### (Structure of an Essential Part of the Image Forming Apparatus)

Explanation will be further given to a mechanical structure of the photoconductor, the image forming unit, the endless belt, and the measurement unit, and an electrical structure of the measurement unit, the calculation unit, and the adjustment unit according to the present invention.

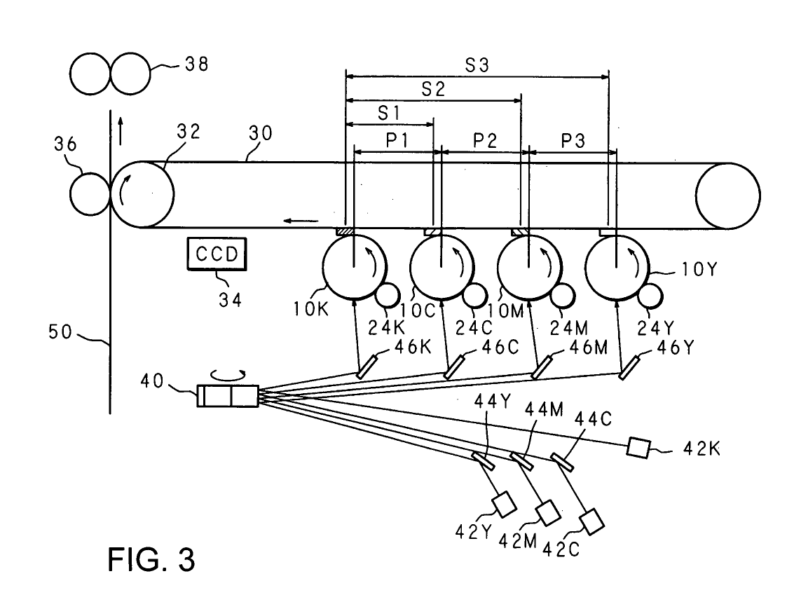

FIG. 3 is an explanatory view schematically showing a mechanical structure of an essential part of the image forming apparatus of the present invention. The intermediate transfer belt 30 in an endless state is driven by a belt drive roller 32 rotating in a clockwise direction toward a sheet surface. A photo sensor 34 is disposed in a lower part of the intermediate transfer belt 30 so as to face its surface. Note that the photo sensor 34 is disposed on a lower stream side of the photoconductor drum 10K along the rotating direction of the intermediate belt 30, namely, between the photoconductor drum 10K and the secondary transfer roller 36.

In addition, the secondary transfer roller 36 is disposed so as to face the belt drive roller 32, with the intermediate transfer belt 30 sandwiched between them. The recording sheet 50 fed from the sheet feeding cassette 16 or the manual sheet feeding tray 17 passes between the secondary transfer roller 36 and the intermediate transfer belt 30.

L1 shown in FIG. 3 is a distance from a position (K transfer part) where the photoconductor drum 10K is in contact with the intermediate transfer belt 30, to the photo sensor 34. As an example, the distance L1 is 280 mm.

FIG. 4 is a block diagram showing an electric structure of the essential part of the image forming apparatus of the present invention. As shown in FIG. 4, the image forming apparatus 100 includes the photo sensor 34 as an input section and an image input section 62. Also, an LSU 64 as a control object and a drive section 66 are included. Further, a controlling unit 60 that processes a signal or data from the input section and controls the control object, an RAM 68, and an ROM 70 are included. Further, the image forming apparatus 100 includes photoconductor drums 10K, 10C, 10M, 10Y as driving loads, the belt drive roller 32 and the polygon mirror 40.

The photo sensor 34 serves as a sensor for reading the adjustment pattern formed on the intermediate transfer belt 30. The image input section 62 acquires data of the image to be outputted from outside. A source for providing the image data serves as equipment connected to the image forming apparatus 100 via a communication line. A host such as a personal computer is given as an example of the equipment. An image scanner is given as another example. The image thus acquired is stored in the RAM 68 for print processing.

The controlling unit 60 is specifically the CPU or a micro computer. The RAM 68 provides a work area for the controlling unit to work and an area as an image memory to store the image data. Information showing its attribute is added to the image data acquired from the image input section 62. The added attribute includes a vertical and horizontal size of each image and the kind of the monochromatic image and the color image. The controlling unit 60 stores the acquired image data in the RAM 68 so as to correspond to the added attribute. The image data is stored in the RAM 68 by every job, and further is stored by every page when one job is composed of a plurality of pages. When the image data is inputted from an outside host and is formatted by a page description language, the controlling unit 60 develops the inputted image data and stores it in the image memory area.

The ROM 70 stores a program that defines a processing procedure executed by the controlling unit 60. Further, the ROM 70 stores pattern data for generating the aforementioned pattern. The controlling unit 60 controls a drive of the driving load shown in the figure. Further, the controlling unit 60 controls the operation of each part of a constituent section of the image forming apparatus 100 not shown in FIG. 4.

The LSU 64 receives the signal based on the image data stored in an image memory area in the RAM 68 through an image processing section not shown. The image processing section processes the image data and provides to the LSU 64 a modulation signal according to each pixel of the image to be outputted. Note that the modulation signal is provided for each color component of yellow, magenta, cyan, and black. The modulation signal of yellow is used for modulating light emission of a laser diode 42Y disposed in the LSU 64. Each modulation signal of magenta, cyan, and black is used for modulating the light emission of the laser diode 42M, 42C, 42K in the LSU 64.

The drive section 66 includes drum drive motors 26K, 26C, 26M, 26Y, and a belt drive motor 28. The drum drive motor 26 is a motor for driving the photoconductor drums 10K, 10C, 10M, 10Y. The belt drive motor 28 drives a belt drive roller 32. Further, the drive section 66 includes a motor (not shown) for driving the polygon mirror 40. Note that the controlling unit 60 controls the motor for driving loads of a surface of the photoconductor drum 10 and the intermediate transfer belt 30, so that peripheral surfaces thereof are moved at an equal constant speed.

### (Outline of Formation of the Adjustment Image Pattern, Measurement, and an Adjustment Procedure)

Subsequently, explanation will be given for an outline of a formation of the adjustment pattern, a measurement of the position of the formed adjustment pattern, and an adjustment procedure based on a measurement result.

When the adjustment pattern is formed, the controlling unit 60 acquires pattern data previously stored in the ROM 70. The acquired pattern data is developed in an image memory area and the adjustment pattern is prepared. Thereafter, the controlling unit 60 transmits the data of the developed pattern to the LSU 64. The laser diode of the color component that receives the data forms the electrostatic latent image of the pattern on the photoconductor drum. The developing unit 24 develops the formed electrostatic latent image and forms a toner image of the pattern. The toner image of each color component is transferred on the intermediate transfer belt 30.

The photo sensor 34 reads the formed pattern of each color component. The controlling unit 60 performs adjustment of the image, based on information obtained from the read pattern of each color component.

An example of the adjustment of the color misregistration will be explained hereunder. The controlling unit 60 compares a detection timing of each color component read by the photo sensor 34 with a timing of the reference and obtains the deviation. The deviation of the timing can be converted to the deviation of the position by using a peripheral moving speed of the intermediate transfer belt 30. Here, the controlling unit 60 may set a particular color component as a reference color, so that the pattern of the reference color may be the reference for obtaining the deviation.

When the adjustment pattern is formed, under a control of the controlling unit 60, the laser diode 42 of each color component emits light simultaneously and a surface of each photoconductor drum 10 is simultaneously exposed to light. In this way, as shown in FIG. 3, each pattern of black, cyan, magenta, and yellow is transferred to the intermediate transfer belt 30 at the same timing. In this case, the interval between patterns transferred to the intermediate transfer belt 30 is equal to the interval between photoconductor drums 10. As shown in FIG. 3, an axial interval between photoconductor drums 10K and 10C is P1. The axial interval between photoconductor drums 10C and 10M is P2. Also, the axial interval between photoconductor drums 10M and 10Y is P3. For example, each of distances P1, P2, and P3 is respectively 100 mm, and a diameter of each photoconductor drum 10 is respectively 30 mm.

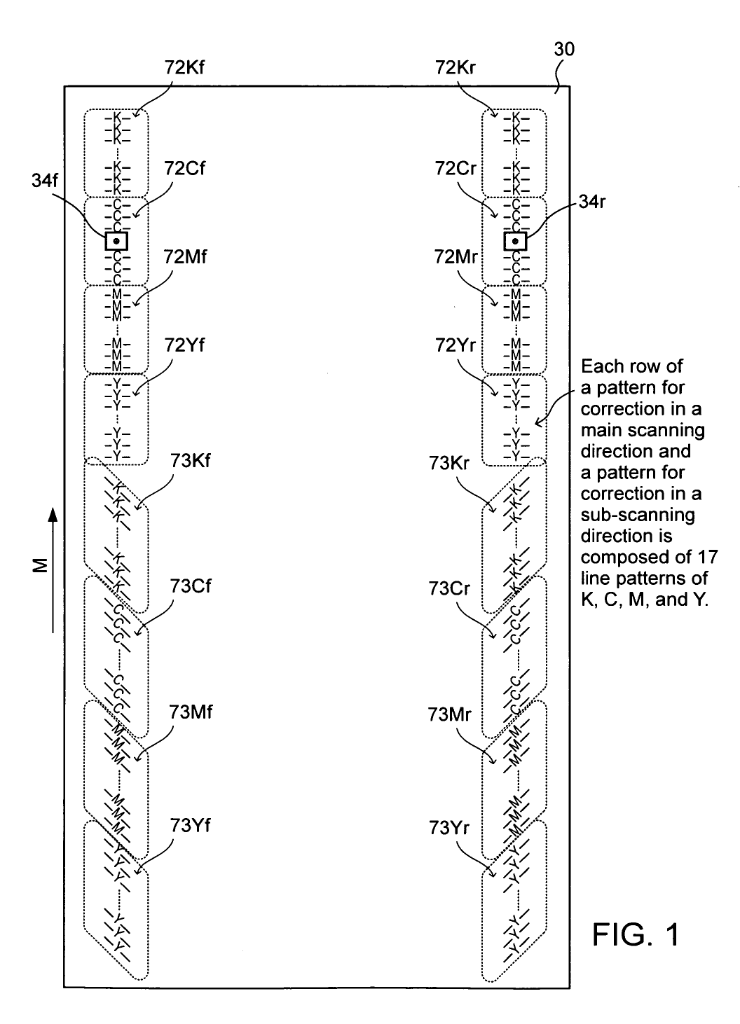

Here, explanation will be given for an example of the procedure for obtaining the position where the pattern of each color component is formed, under the control of the controlling unit 60. FIG. 1 is an explanatory view showing an example of the adjustment pattern formed on the intermediate transfer belt 30. FIG. 1 is a view showing the transfer belt 30 viewed from a lower side, and the circumference of the intermediate transfer belt 30 moves from the lower side to an upper side of FIG. 1 (in a direction shown by arrow M). Photo sensors 34f and 34r are reflective type photo sensors, and are disposed in opposition to the intermediate transfer belt 30. In addition, two photo sensors 34f and 34r are arranged on a straight line extending in the width direction (corresponding to the main scanning direction), and are disposed on both ends of the intermediate transfer belt 30.

As shown in FIG. 1, adjustment pattern groups 72Kf, 72Cf, 72Mf, 72Yf, 73Kf, 73Cf, 73Mf, and 73Yf are sequentially formed on one end side of the intermediate transfer belt 30. Patten group 72Kr, 72Cr, 72Mr, 72Yr, 73Kr, 73Cr, 73Mr, 73Yr are formed on the other end side, so that the adjustment pattern groups are formed on both end parts. Each pattern group is composed of one color component, and is composed of 17 line patterns arranged in the sub-scanning direction. Accordingly, in FIG. 1, a length of 17 patterns arranged in the sub-scanning direction to constitute one pattern group is equal to the peripheral length of the photoconductor drum 10 of its color component. The deviation obtained for each pattern is influenced by the deviation of the photoconductor drum 10 as one of the disturbance components. By averaging the deviations of 17 patterns, the disturbance component caused by the eccentricity can be suppressed.

Note that in FIG. 1, in order to show the color of each line pattern, letters of K, C, M, Y are attached to the pattern. However, this is only for explanation and an actual pattern is a straight line pattern (line pattern) not including a letter pattern. Also, a rectangular and parallelogrammatic chain line is only for explanation for showing the pattern of each pattern group as a set, and the chain line is not thereby formed on the transfer belt 30. The adjustment pattern includes pattern groups 72Kf, 72Kr, 72Cf, 72Cr, 72Mf, 72Mr, 72Yf, and 72Yr, and further includes pattern groups 73Kf, 73Kr, 73Cf, 73Cr, 73Mf, 73Mr, 73Yf, and 73Yr, with each pattern extending at an angle of 45 degrees in the main scanning direction.

Under the controlling unit 60, according to a signal from the photo sensor 34, the timing for passing through a tip end and a rear end of each line pattern is obtained, when each line pattern passes through the photo sensor 34. An average value of the obtained tip end passing timing and rear end passing timing is set as the timing when a center of each line pattern passes through. The controlling unit 60 temporarily stores such an obtained passing timing of each line pattern in the RAM 68.

In addition, as shown in FIG. 1, 17 line patterns are arranged as the pattern of each color component. Under the control of the controlling unit 60, the average of the passing timing of each of the 17 line patterns is further obtained and an average value thus obtained may be set as the timing corresponding to the position where each color component is formed. The time corresponding to intervals S1, S2, S3 of the pattern of each color component shown in FIG. 3 is calculated from the obtained timing and the peripheral moving speed of the intermediate transfer belt 30. Interval S1 is the interval between the pattern of the reference color (black) and the pattern of cyan. Interval S2 is the interval between the pattern of the reference color (black) and the pattern of magenta. Interval S3 is the interval between the pattern of the reference color (black) and the pattern of yellow.

How to adjust the image by using each pattern will be explained hereunder. The image forming apparatus according to this embodiment measures four elements of the color misregistration and performs adjustment based on a measurement result.

A first element is a pitch fluctuation component in the sub-scanning direction corresponding to the rotation period of the photoconductor drum 10. This pitch fluctuation component is called a sub-scanning AC component hereunder. This element is considered to be mainly caused by the eccentricity of the photoconductor drum 10 or its drive system. The adjustment is applied to this element, by measuring the phase of the pitch fluctuation regarding each color of black, cyan, magenta, and yellow, respectively, and adjusting a rotating phase of the photoconductor drums of cyan, magenta, and yellow with respect to the rotating phase of photoconductor drum 10K of black. Each photoconductor drum is driven by an independent drum drive motor respectively. Accordingly, by rotating other photoconductor drum when the photoconductor drum 10K stops, the rotating phase can be adjusted.

A second element is an offset of cyan, magenta, and yellow, against black in the sub-scanning direction. Such an offset is called a sub-scanning direct current component (sub-scanning DC component) hereunder. This element is mainly caused because the peripheral moving speed of the intermediate transfer belt 30 is changed, due to a thermal expansion of the belt drive roller 32. The adjustment is possible to this element by changing a writing start timing of the sub-scanning line of cyan, magenta, and yellow, against black.

A third element is the offset of cyan, magenta, and yellow, against black in the main scanning direction. Such an offset is called a main scanning DC component (main scanning DC component) hereunder. This element is mainly caused by the thermal expansion of an exposure optical system such as a polygon mirror 40. The adjustment is possible to this element, by changing a writing start position of the main scanning line of cyan, magenta, and yellow against black, namely, by changing a light emission start timing of the laser diode 42.

A fourth element is a magnification error of cyan, magenta, and yellow against black in the main scanning direction. This magnification error is called a main scanning magnification component hereunder. In the same way as the third element, this element is considered to be caused by the thermal expansion of the exposure optical system such as the polygon mirror 40. The adjustment is possible to this element, by changing a pixel clock frequency of the main scanning line of cyan, magenta, and yellow against black, namely, by changing a modulation frequency of the laser diode 42.

### (Adjustment of the Sub-Scanning AC Component)

Adjustment contents of the aforementioned four elements of the color misregistration will be sequentially explained.

First, explanation will be given for the adjustment of the sub-scanning AC component, being the first element of the color misregistration, citing black as an example. Similar adjustment is also applied to other colors.

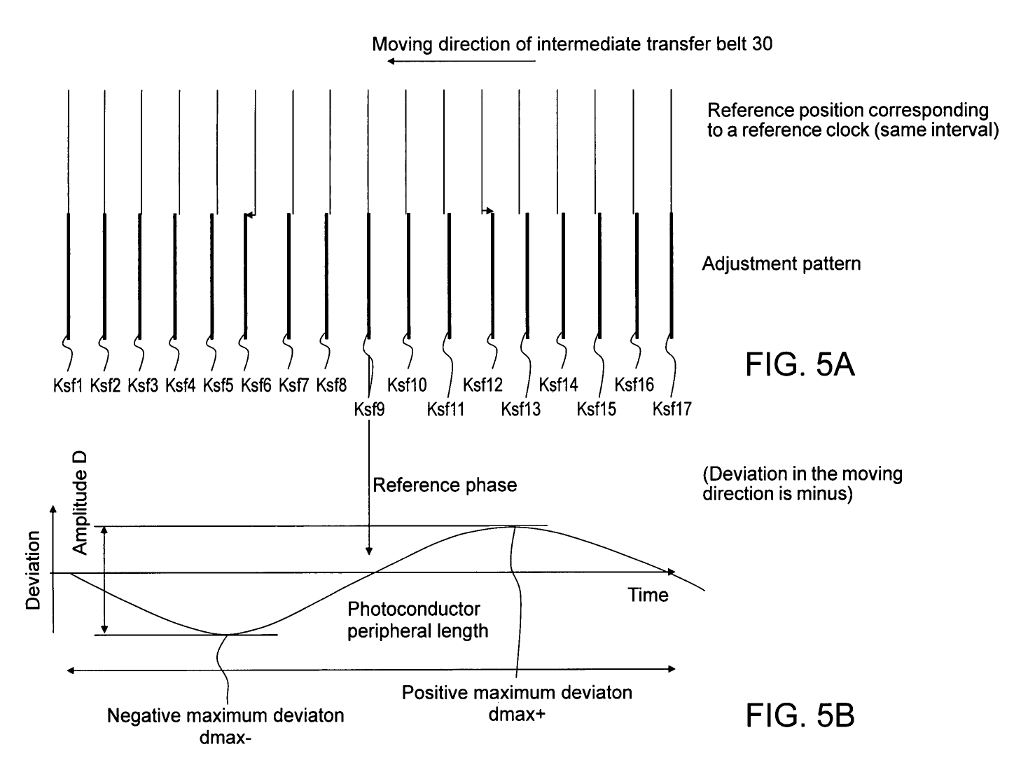

Under the control of the controlling unit 60, the phase of the pitch fluctuation component in the sub-scanning direction is obtained from the adjustment pattern groups 72Kf, 72Kr, 73Kf, 73Kr (see FIG. 1). For example, the timing when each pattern Ksf1 to Ksf17 of the pattern group 72Kf passes through the photo sensor 34f is compared to a reference clock, and the deviation (pitch fluctuation component) of a detection result of each pattern with respect to a previously defined reference value is obtained. FIG. 5 is an explanatory view showing an example of the reference clock and a detection timing of the adjustment pattern. FIG. 5A shows the detection timing of each pattern with respect to the reference value. The time is taken on the horizontal axis. FIG. 5B is a graph showing a transition with time of the detected deviation, with the detection timing of each pattern of FIG. 5A taken on the horizontal axis, and the deviation of each pattern taken on the vertical axis.

Note that the “deviation” in the explanation of the sub-scanning AC component refers to positive/negative signed numerical values corresponding to the measurement result of each straight line of a toner pattern. Namely, each deviation is a value showing a deviation from a reference position. The positive/negative of sign shows a direction of the deviation, and for example, a direction showing a delay of each straight line from the reference position is set as “positive”. The pitch fluctuation component corresponds to a time-series set of each deviation. Although each deviation amount is only one numerical value, the pitch fluctuation component, being the time-series set of this deviation amount, changes periodically. Accordingly, the pitch fluctuation component has a phase and amplitude.

Even if the eccentricity of the photoconductor drum 10 or its drive system is given as a maximum factor of the pitch fluctuation in the sub-scanning direction, the other factor exists. It is found that the eccentricity of the belt drive roller 32 is given as other main factor. This is a knowledge obtained by the inventors of the present invention, from an analysis of a periodic component of the color misregistration. When the adjustment pattern is measured, other factor causes the accuracy of measurement to be lowered as a disturbance. Therefore, in the image forming apparatus of the present invention, the interval between the adjustment pattern groups 72Kf and 73Kf is set, so that periodic disturbances caused by the eccentricity of the belt drive roller 32 are mutually canceled, and the periodic disturbances caused by the eccentricity of the photoconductor drum 10K are amplified. In addition, the interval between the adjustment pattern groups 72Kr and 73Kr is set. Namely, the controlling unit 60 sets the interval between the pattern groups 72Kf and 73Kf, so that the phases of the periodic disturbance components caused by the eccentricity of the belt drive roller 32 are opposite to each other, and the phases of the periodic fluctuation components caused by the eccentricity of the photoconductor drum 10K are equal to each other.

### Removal of the Pitch Fluctuation Caused by the Eccentricity of the Belt Drive Roller

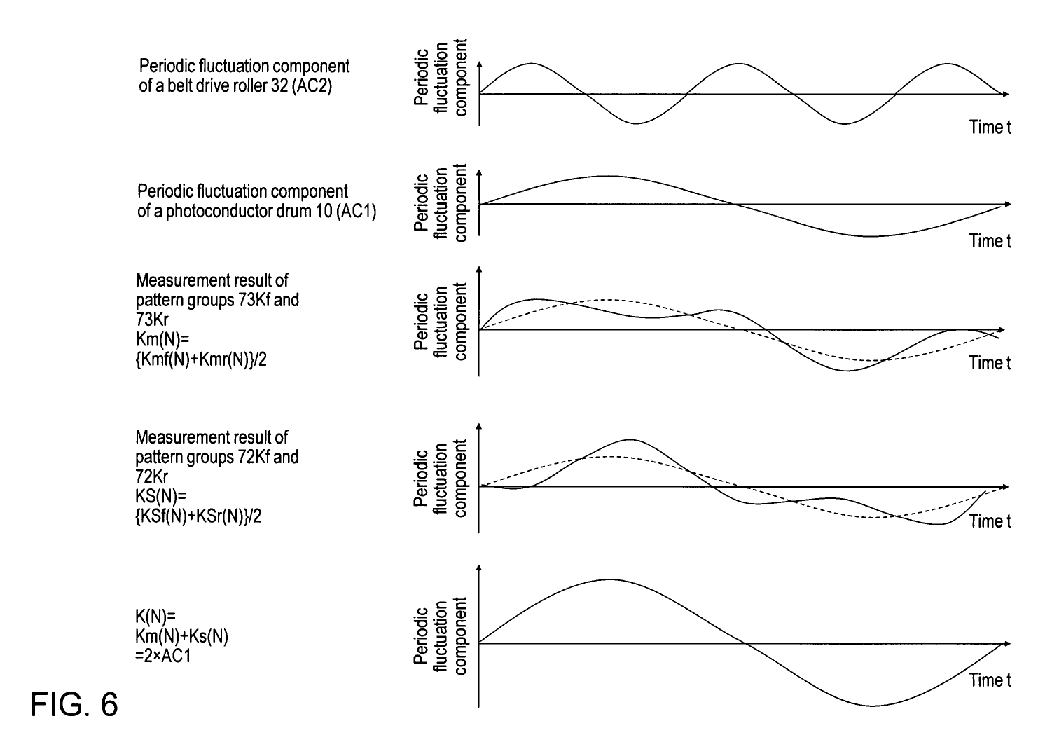

For example, FIG. 6 is an explanatory view showing the removal of the periodic disturbance component by calculating a sum of the deviations of the adjustment pattern groups 72Kf and 73Kf. The pitch fluctuation component is taken on the vertical axis of FIG. 6, corresponding to the vertical axis of FIG. 5B. In FIG. 6, an envelope of pitch fluctuation components Ksf(N), Ksr(N), Kmf(N), Kmr(N), (wherein N is an integral number of 1 to 17) of the pattern groups 72Kf, 72Kr, 73Kf, 73Kr is formed in a waveform in which a period fluctuation AC1 equal to a rotation period of the photoconductor drum 10K and a period fluctuation AC2 equal to the rotation period of the belt drive roller 32 are superposed on each other. The interval between the pattern groups 72Kf and 73Kf is set at a value of m times the peripheral length of the photoconductor and (n+½) times the peripheral length of the drive roller. The same thing can be said for the interval between the pattern groups 72Kr and 73Kr. Here, m and n are integral numbers.

When K(N)=[Kmf(N)+Kmr(N)]/2+[Ksf(N)+Ksr(N)/2 is calculated, the fluctuation component AC1 is added and amplified with the same phase, and the fluctuation component AC2 is added and suppressed with an inverted phase.

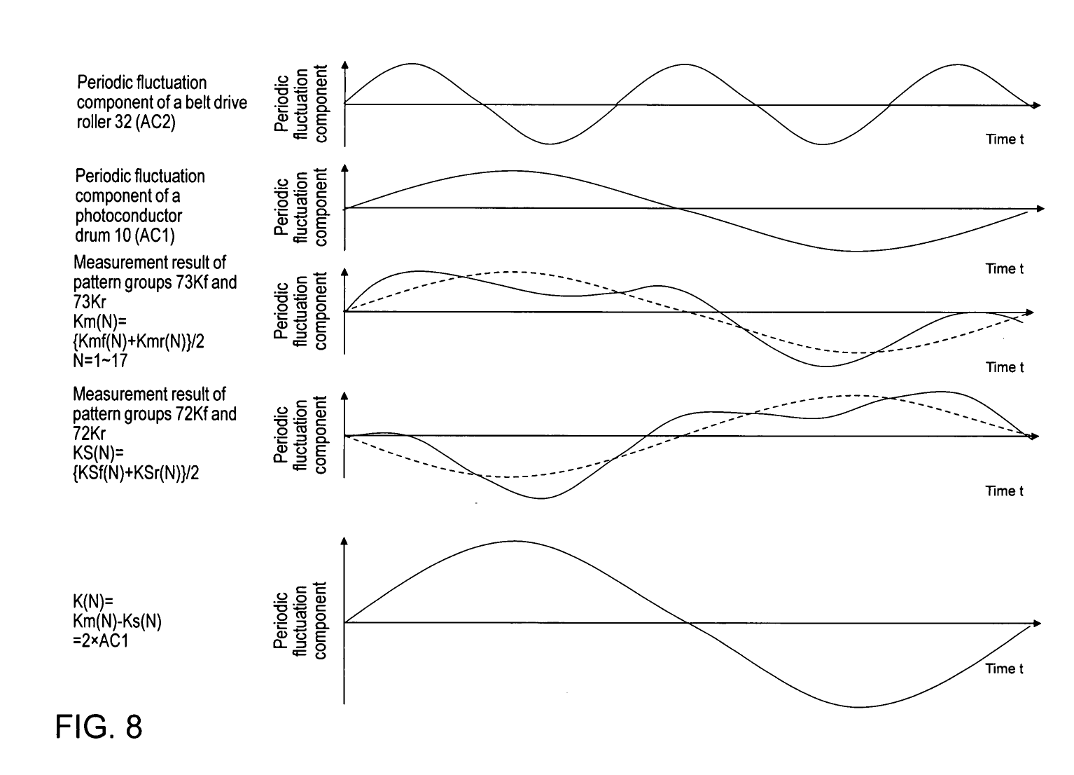

Meanwhile, FIG. 8 is an explanatory view showing the removal of the periodic disturbance component by calculating a difference in the deviations of the adjustment pattern groups 72Kf and 73Kf. The pitch fluctuation component is taken on the vertical axis in FIG. 8. In FIG. 8, the envelope of the pitch fluctuation components Ksf(N), Ksr(N), Kmf(N), Kmr(N) is formed in the waveform in which the period fluctuation AC1 equal to the rotation period of the photoconductor drum 10K and the period fluctuation AC2 equal to the rotation period of the belt drive roller 32 are superposed on each other. The interval between the pattern groups 72Kf and 73Kf is set at a value of (m+½) times the peripheral length of the photoconductor and n times the peripheral length of the drive roller 32. The same thing can be said for the interval between the pattern groups 72Kr and 73Kr. Here, m and n are integral numbers.

When K(N)=[Kmf(N)+Kmr(N)]/2−[Ksf(N)+Ksr(N)]/2 is calculated, the fluctuation component AC1 is subtracted and amplified with an inverted phase and the fluctuation component AC2 is subtracted and suppressed with the same phase.

Note that the peripheral length of the photoconductor and the peripheral length of the drive roller 32 are already defined numerical values in a stage that a design of each apparatus is decided. Accordingly, the controlling unit 60 can set the interval between the pattern groups 72Kf and 73Kf, and the interval between the pattern groups 72Kr and 73Kr, as already defined intervals. Here, the interval between pattern groups refers to the distance between patterns at tip ends or patterns at rear ends, namely, the distance between patterns of corresponding orders from the head. Whether or not the sum is taken as shown in FIG. 6, or the difference is taken as shown in FIG. 8 may be suitably selected by a designer.

### Removal of the Disturbance Due to Meandering of the Intermediate Transfer Belt

Here, the influence of meandering of the intermediate transfer belt 30 is further considered. Even if the intermediate transfer belt 30 is deviated in the main scanning direction by meandering, the pattern groups 72Kf and 72Kr are not influenced thereby, because the patterns are parallel to each other in the main scanning direction. Each pattern of the pattern groups 73Kf and 73Kr obliquely intersects with each other in the main scanning direction, and therefore deviation occurs at the timing of detecting each of them. However, the patterns are obliquely intersecting with each other in an opposite direction, and therefore by averaging the deviations of both patterns, the influence of meandering can be suppressed.

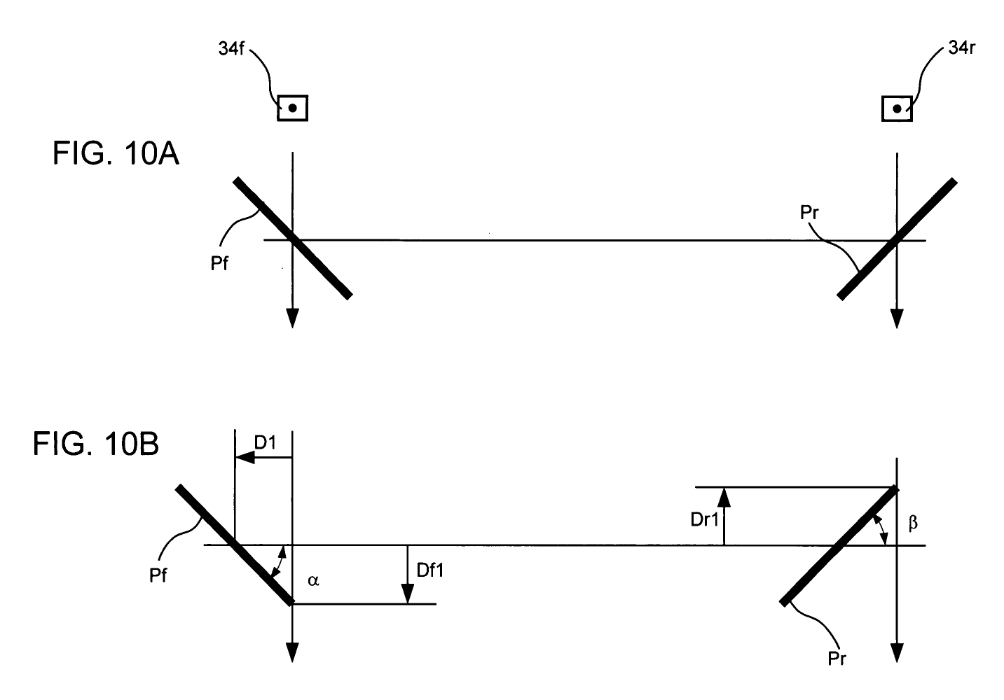

Further explanation will be given in detail hereunder. FIG. 10 is an explanatory view showing the influence on a detection position of a first oblique pattern Pf and a second oblique pattern Pr corresponding to the sub-scanning direction, when the intermediate transfer belt 30 meanders. The pattern Pf is one pattern on the main scanning starting end side. The pattern Pr is one pattern on the main scanning terminate end side corresponding to Pf. For example, the pattern Pf is a pattern Kmf1 of the head of the pattern group 73Kf, and the pattern Pr is a pattern Kmr1 of the head of the pattern group 73Kr. FIG. 10A shows a case that the intermediate transfer belt 30 does not meander and the first and second oblique patterns are formed at a reference position. In this case, the timing for detecting the pattern Pf by the photo sensor 34f and the timing for detecting the pattern Pr by the photo sensor 34r are the same.

As shown in FIG. 10B, when the intermediate transfer belt 30 meanders and deviates to the Pf side by D1, the detection timing of the pattern Pf is delayed from the reference, and the detection timing of the pattern Pr is made earlier than the reference. Therefore, the controlling unit 60 so judges that the forming position of the pattern Pf is set behind the reference by Df1, and the forming position of the pattern Pr is set in front of the reference by Dr1. Here, relational formulas are expressed as:

Df1=D1×tan α [Formula 1]

Dr1=D1×tan β [Formula 2]

The average of both of them (Df1+Dr1) is zero, when α and β are equal to each other, thus offsetting the influence of meandering. However, even if α and β are not equal to each other, the disturbance component of meandering can be suppressed by averaging.

In addition, as shown in FIG. 10C, when the intermediate belt is deviated to the pattern Pr side by D2, the detection timing of the pattern Pf is made earlier than the reference, and the detection timing of the pattern Pr is delayed from the reference. Therefore, the controlling unit 60 so judges that the forming position of the pattern Pf is set in front of the reference by Df2, and the forming position of the pattern Pr is set behind the reference by Dr2. Here, the relational formulas are expressed as:

Df2=D2×tan α [Formula 3]

Dr2=D2×tan β [Formula 4]

The average of both of them (Df2+Dr2) is zero, when α and β are equal to each other, thus offsetting the influence of meandering. However, even if α and β are not equal to each other, the disturbance component of meandering can be suppressed by averaging.

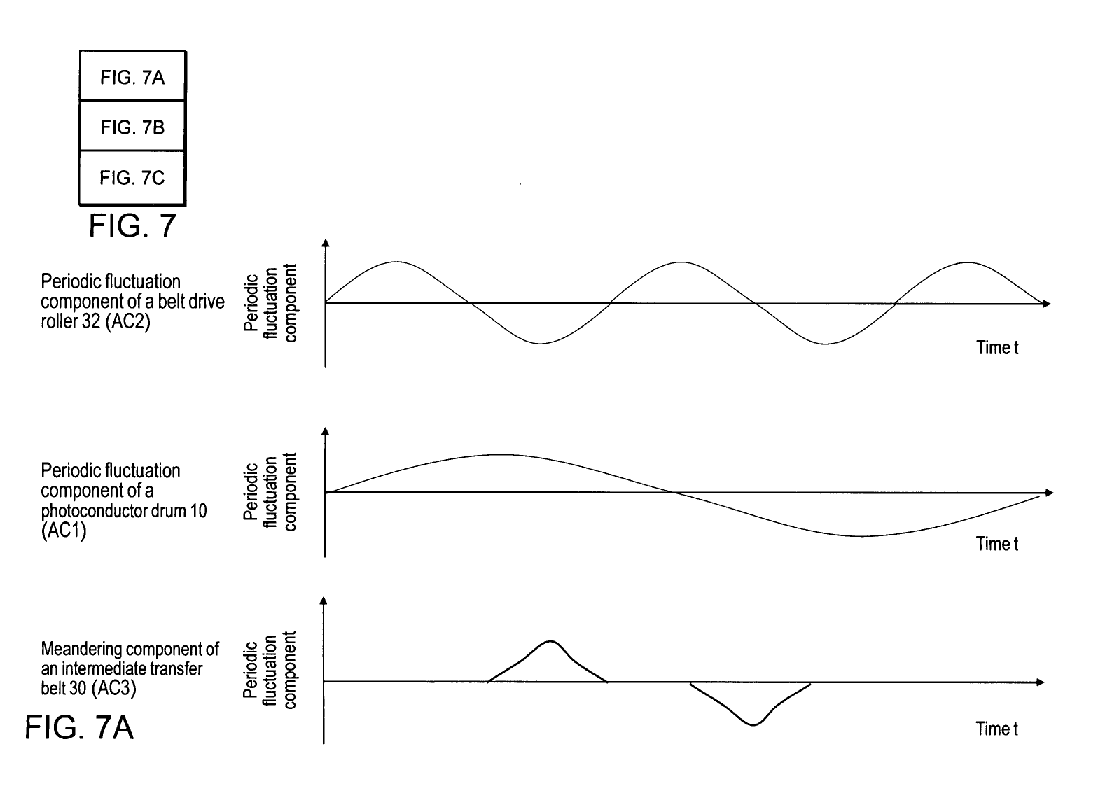

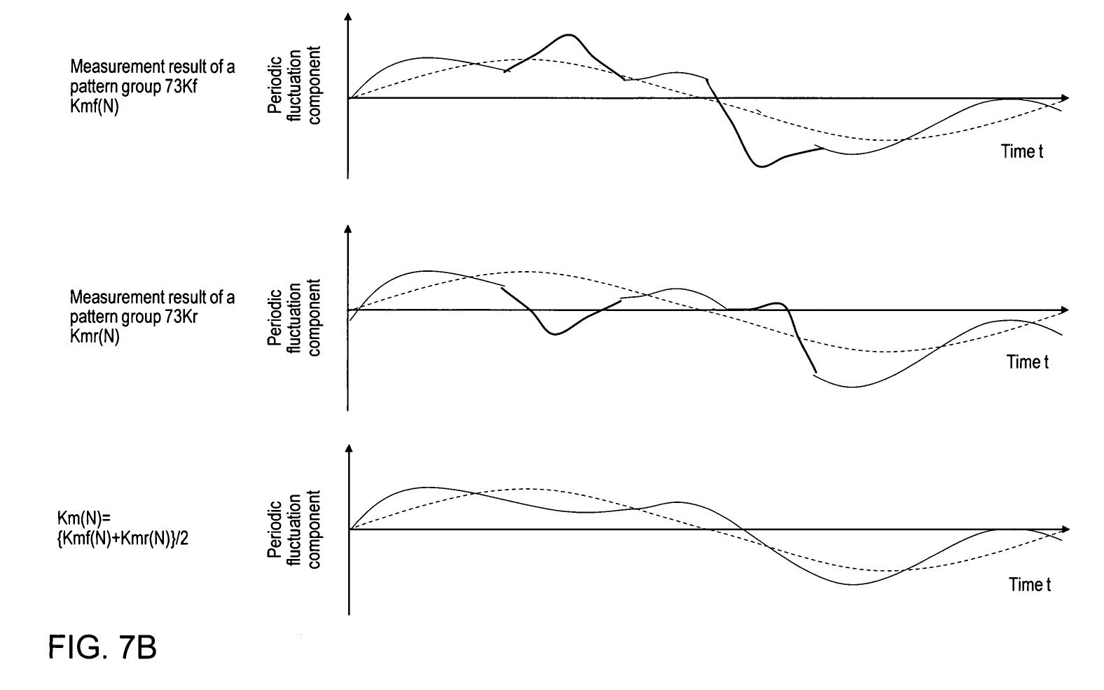

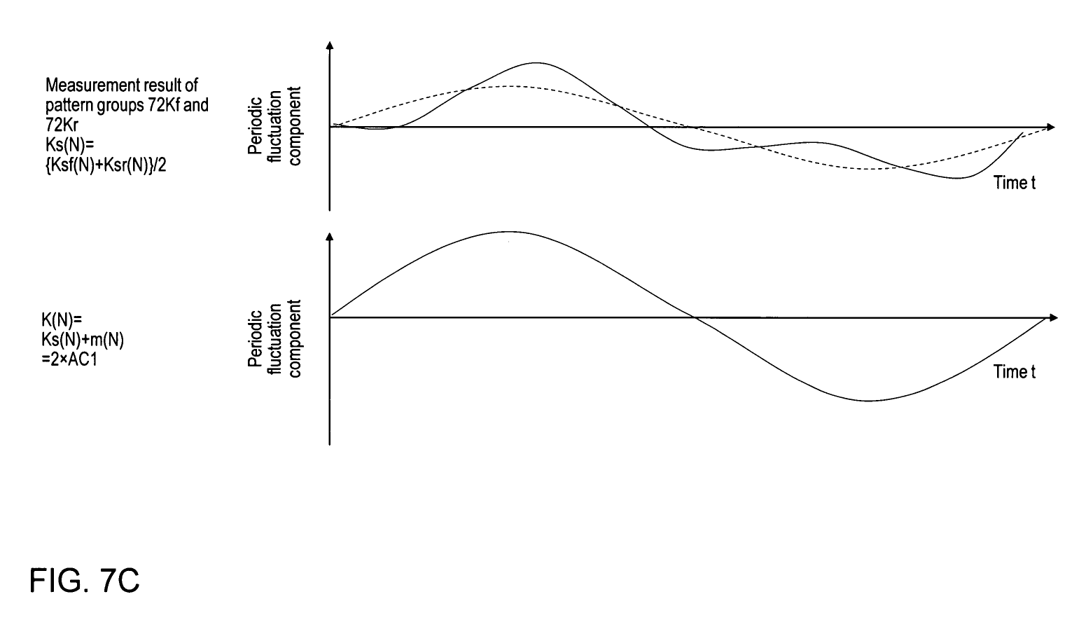

FIG. 7 is an explanatory view showing a condition that a meandering component of FIG. 6 is further suppressed. When the fluctuation component caused by meandering is represented by AC3, the fluctuation component AC3 is detected in an opposite direction, in the pattern group 73Kf and in the pattern group 73Kr. When the pitch fluctuation components Kmf(N) and Kmr(N) of both of them are averaged, the fluctuation component AC3 is suppressed, and the fluctuation components AC1 and AC2 remains. Accordingly, when K(N)=[Kmf(N)+Kmr(N)]/2+[Ksf(N)+Ksr(N)]/2 is calculated from the pitch fluctuation component of the pattern groups 72Kf, 72K4, 73Kf, and 73Kr, the fluctuation component AC1 is added and amplified with the same phase, and the fluctuation components AC2 and AC3 are added and suppressed with the inverted phase.

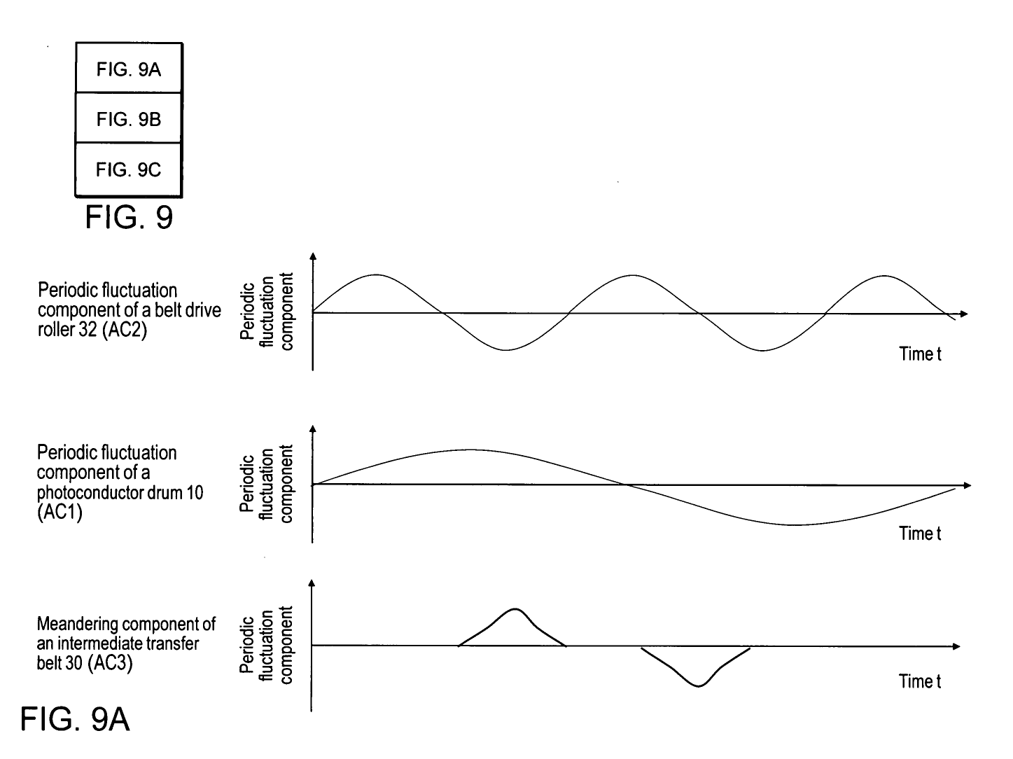

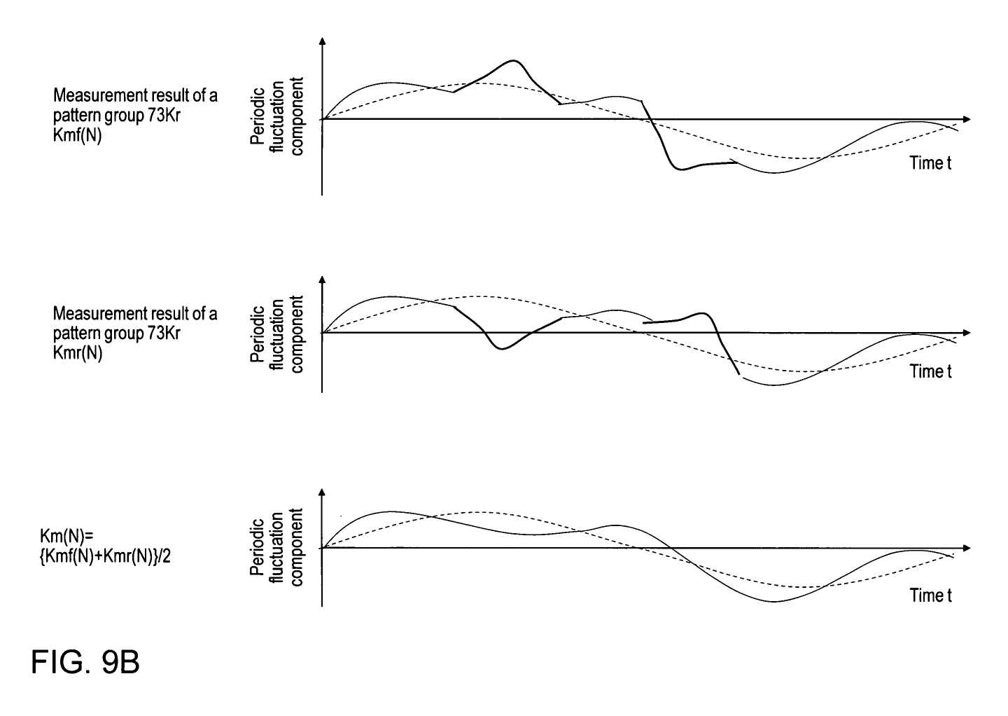

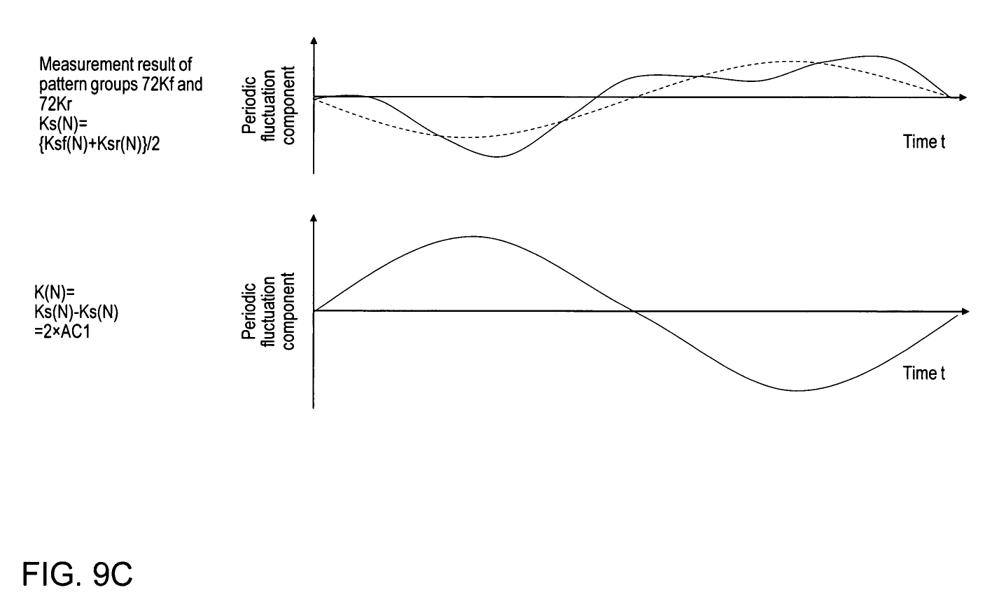

FIG. 9 is an explanatory view showing a condition that the meandering component of FIG. 8 is further suppressed. By averaging the pitch fluctuation components Kmf(N) and Kmr(N), the fluctuation component AC3 is suppressed and the fluctuation components AC1 and AC2 remain.

When K(N)=Km(N)−Ks(N)=[Kmf(N)+Kmr(N)]/2−[Ksf(N)+Ksr(N)]/2 is calculated, the fluctuation component AC1 is subtracted and amplified with the inverted phase and the fluctuation component AC2 is subtracted and suppressed with the same phase, and the fluctuation component AC3 is added and suppressed with the inverted phase.

Note that if only the measurement of the AC component in the sub-scanning direction is referred to, the pattern groups 73Kf and 73Kr may be the patterns (corresponding to the first and second horizontal patterns) parallel to the main scanning direction, in the same way as the pattern groups 72Kf and 72Kr. However, only the deviation amount in the sub-scanning direction can be obtained from the first and second horizontal patterns. Namely, the adjustment in the sub-scanning direction and the adjustment in the main scanning direction cannot be performed at the same time. According to this embodiment, by using the pattern groups 73Kf and 73Kr in the adjustment in the main scanning direction, it is so considered that the total number of the patterns is not increased.

### Explanation for a Flowchart

FIG. 14 is a flowchart showing a calculation procedure of the sub-scanning AC component, citing black as an example. Note that processing in FIG. 14 is performed after finishing the measurement of each pattern. Explanation will be given for a procedure of obtaining a reference phase of the fluctuation component AC1, along the flowchart of FIG. 14. As shown in FIG. 14, first, the controlling unit 60 sets N as an initial value of a loop counter N (step S51). Then, the deviation is obtained, by comparing the detection timing of the pattern Ksf(N) with the reference (step S53). Here, Ksf(N) is the N-th pattern from the head of the pattern group 72Kf. For example, when N=1 is established, the pattern is obtained as a pattern Ksf1. Further, the controlling unit 60 obtains the deviation of the pattern Ksr(N) (step S55). Here, Ksr(N) is the N-th pattern from the head of the pattern group 72Kr. Then, average Ks(N) of the deviation of Ksf(N) and Ksr(N) is obtained (step S57). Ks(N) is the average of the deviation of the N-th pattern from the head of the pattern groups 72Kf and 72Kr. By averaging, the fluctuation component AC3 due to meandering is suppressed.

Note that according to this embodiment, as a preferable aspect of the present invention, the deviation is obtained for Ksf(N) and Ksr(N), and further the average thereof is obtained (steps S53 to 57). However, the average needs not necessarily be obtained for the pattern Ks, namely, a horizontal pattern. Namely, steps S53 and S57 are omitted, and in step S65, Km(N) and Ksr(N) may be added to obtain K(N). Alternately, steps S55 and S57 are omitted, and in step S65, Km(N) and Ksf(N) are added to obtain K(N).

Further, the controlling unit 60 obtains the deviation of the pattern Kmf(N) (step S59). Here, Kmf(N) is the N-th pattern from the head of the pattern group 73Kf. Further, the deviation of the pattern Kmr (N) is obtained (step S61). Here, Kmr(N) is the N-th pattern from the head of the pattern group 73Kr. Then, average Km(N) of the deviations of Kmf(N) and Kmr(N) is obtained (step S63). Km(N) is the average of the deviation of the N-th pattern from the head of the pattern groups 73Kf and 73Kr. By averaging, the fluctuation component AC3 due to meandering is suppressed.

Thereafter, the controlling unit 60 adds Ks(N) and Km(N) to obtain K(N) (step S65). By adding, the fluctuation component AC2 caused by the eccentricity of the belt drive roller 32 is suppressed, and the fluctuation component AC1 caused by eccentricity of the photoconductor drum is amplified.

The controlling unit 60 repeats the processing of steps S53 to S65 until the loop counter N reaches 17 (steps S67, 71). Namely, deviations K(1) to K(17) of 17 patterns of the pattern groups 72Kf, 72Kr, 73Kf, 73Kr are obtained. From the obtained deviation, the reference phase of the fluctuation component AC1 is obtained (step S69). The reference phase may be obtained as an intermediate position, being the position capable of giving a maximum deviation d max and a minimum deviation d min shown in FIG. 5B.

### (Adjustment of the Sub-Scanning DC Component)

Next, explanation will be given for the adjustment of the DC component in the sub-scanning direction, being the second element of the color misregistration. Here, explanation is given for the adjustment in the sub-scanning direction when black is set as a reference color. The adjustment is performed by the controlling unit 60, so that a pattern interval S1 of cyan corresponding to black is made equal to an interval P1 (see FIG. 3) between the photoconductor drums 10K and 10C. Namely, the adjustment of the forming position of a cyan image in an image formation thereafter is performed, so that the difference between intervals S1 and P1 can be a previously defined threshold value or less. The interval P1 is a previously defined value. The adjustment of the forming position can be performed by changing a light emission start timing of the laser diode 42C. More specifically, the adjustment in the sub-scanning direction can be realized by changing the light emission start timing in each scanning line.

Further, the controlling unit 60 performs adjustment, so that a pattern interval S2 of magenta against black is made equal to an interval (P1+P2) between the photoconductor drums 10K and 10M. Namely, the adjustment of the forming position of a magenta image in the image formation thereafter is performed, so that the difference between the interval S2 and the interval (P1+P2) is a previously defined threshold value or less. In the same way as P1, the interval P2 is a previously defined value. The adjustment of the forming position is realized by the adjustment of the light emission start timing of the laser diode 42M.

Still further, the controlling unit 60 performs adjustment, so that a pattern interval S3 of yellow against black is made equal to an interval (P1+P2+P3) between the photoconductor drums 10K and Y. Namely, the forming position of a yellow image in the image formation thereafter is adjusted, so that the difference between an interval S3 and the interval (P1+P2+P3) is a previously defined threshold value or less. In the same way as P1 and P2, the interval P3 is a previously defined value. The adjustment of the forming position is realized by adjusting the light mission timing of the laser diode 42Y.

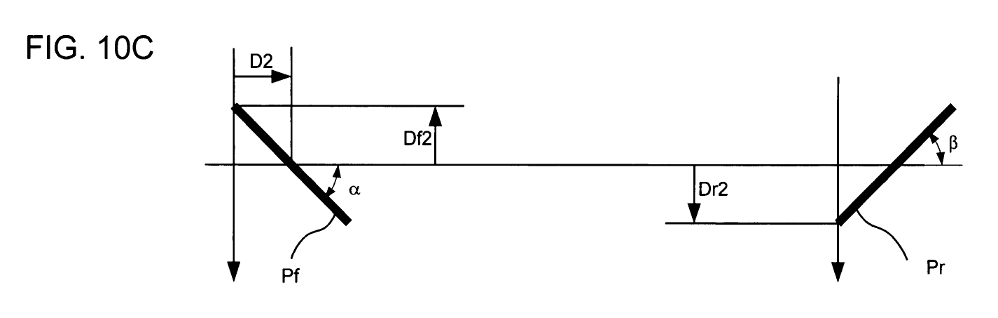

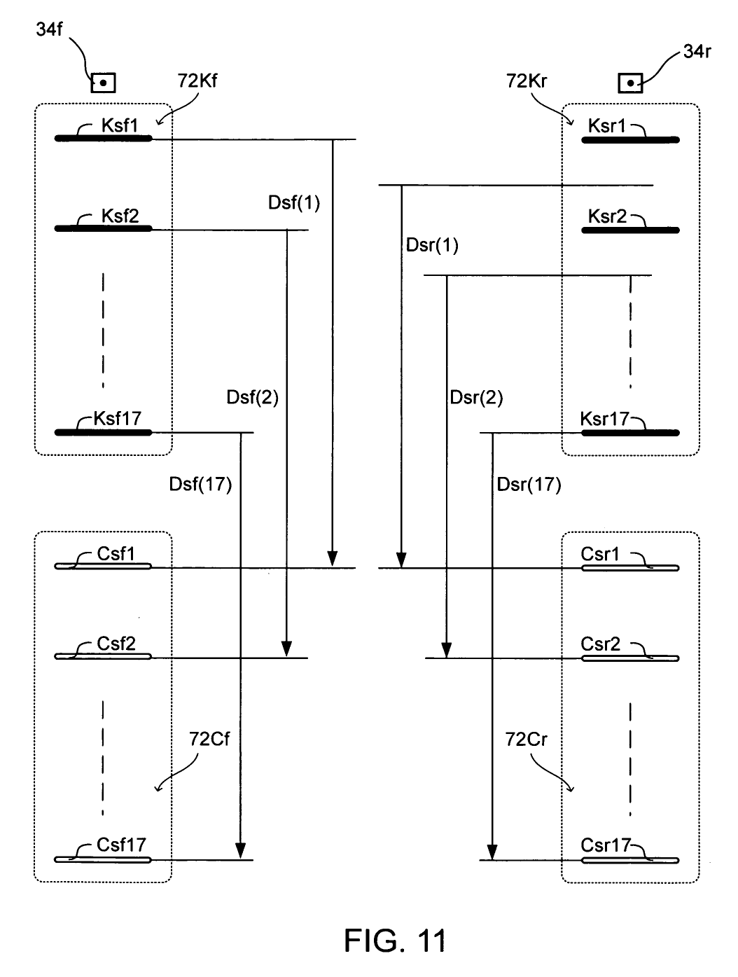

The above-described explanation is applied to the adjustment pattern shown in FIG. 1, and the following explanation will be given. FIG. 11 is an explanatory view showing to simplify only a part related to the adjustment of the sub-scanning DC component of cyan out of the adjustment patterns of FIG. 1. In addition, FIG. 15 is a flowchart showing a procedure for obtaining the deviation of the sub-scanning DC component, citing cyan as an example. The processing of FIG. 15 is performed after the measurement of each pattern is finished. Explanation will be given along the flowchart of FIG. 15, while referring to FIG. 11.

First, the controlling unit 60 initializes the loop counter N (step S81). Subsequently, distance Dsf(N) between the N-th pattern Ksf(N) from the head of the pattern group 72Kf and the N-th pattern Csf(N) from the head of the pattern group 72Cf is obtained by measurement. Then, the deviation with respect to the reference value is obtained (step S83). Further, distance Dsr(N) from the N-th pattern Ksr(N) from the head of the pattern group 72Kr to the N-numbered pattern Csr(N) from the head of the pattern group 72Cr is obtained by measurement. Then, the deviation with respect to the reference value is obtained (step S84). By averaging the obtained deviations, an average deviation Cs(N) is obtained (step S87). The processing of steps S83 to S87 is repeated until the loop counter N reaches 17 (steps S89, S93). Thus, average deviations Cs(1) to Cs(17) are obtained. Then, average Cs of the obtained deviations Cs(1) to Cs(17) is obtained, and a difference Dc_subC between Cs and the reference value P1 is obtained (step S91). The Dc_subC is the deviation of the sub-scanning DC component of cyan.

By averaging 17 intervals Cs(1) to Cs(17) in the sub-scanning direction, the disturbance caused by the eccentricity of the photoconductor drum 10C can be suppressed.

By the same procedure, the controlling unit 60 measures each pattern of magenta and obtains a deviation Dc_subM of magenta in the sub-scanning direction. In addition, the controlling unit 60 measures each pattern of yellow and obtains a deviation Dc_subY of yellow in the sub-scanning direction.

The controlling unit 60 determines an adjustment amount of the writing start timing in the sub-scanning direction based on each deviation thus obtained.

### (Adjustment of the Main Scanning DC Component)

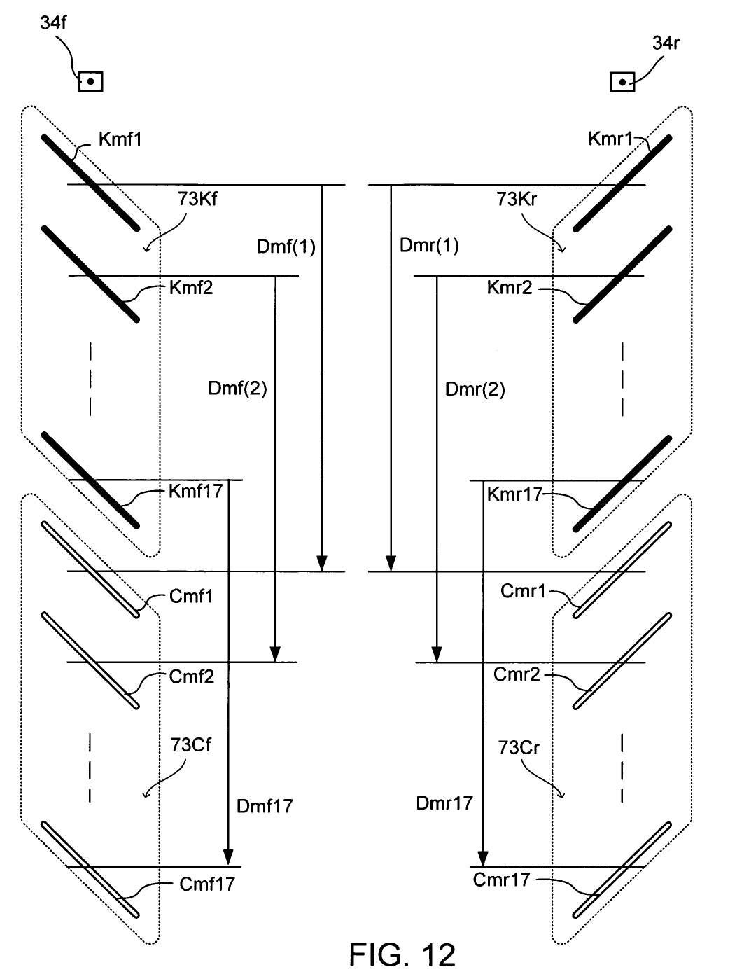

Subsequently, explanation will be given for the adjustment of the DC component in the main scanning direction, being the third element of the color misregistration. Here, cyan is cited as an example to explain for the adjustment of the main scanning DC component, with black as a reference. FIG. 12 is an explanatory view simply showing a part related to the adjustment in the main scanning direction out of the adjustment pattern of FIG. 1. The adjustment of the main scanning DC component is performed by obtaining an adjustment amount by measuring the deviation of the pattern on the main scanning starting end side. FIG. 16 is a flowchart showing the procedure for obtaining the deviation on the main scanning starting end side. The processing of FIG. 16 is performed after the measurement of each pattern is finished. Explanation will be given along the flowchart of FIG. 16, while referring to FIG. 12.

First, the controlling unit 60 initializes the loop counter N (step S101). Subsequently, distance Dmf(N) between the N-numbered pattern Kmf(N) from the head of the pattern group 73Kf and the N-numbered pattern Cmf(N) from the head of the pattern group 73Cf is obtained by measurement. Then, the deviation with respect to the reference value is obtained (step S103). Here, the reference value is a value obtained by subtracting the deviation Dc_subC from the interval P1 in the sub-scanning direction. The controlling unit 60 repeats the processing of step S103 until the loop counter N reaches 17 (steps S105, S109). Thus, each deviation of Cmf(1) to Cmf(17) is obtained. Then, a deviation Dc_mnfc on the main scanning starting end side is obtained, as the average of each deviation of the obtained Cmf(1) to Cmf(17) (step S107). By obtaining the average of Cmf(1) to Cmf(17), the disturbance caused by the eccentricity of the photoconductor drum 10C is suppressed.

As for magenta also, in the same procedure, the controlling unit 60 obtains deviation Dc_mnfM on the main scanning starting end side by using pattern groups 73Kf and 73Mf. As for yellow also, in the same procedure, deviation Dc_mnfY on the main scanning starting end side is obtained by using pattern groups 73Kf and 73Yf.

Based on each deviation thus obtained, the controlling unit 60 determines the adjustment amount of the writing start timing in the main scanning direction.

### (Adjustment of the Main Scanning Magnification Component)

Further subsequently, explanation will be given for the adjustment of a magnification component in the main scanning direction, being the fourth element of the color misregistration. Here, explanation will be given for the adjustment of a main scanning magnification component, with black as a reference. In order to adjust the magnification component, first, the controlling unit 60 obtains the deviation on the main scanning terminate end side. FIG. 17 is a flowchart showing the procedure for obtaining the deviation on the main scanning terminate end side, citing cyan as a reference. The processing of FIG. 17 is performed after the measurement of each pattern is finished. Explanation will be given along the flowchart of FIG. 17 hereunder, with reference to FIG. 12.

First, the controlling unit 60 initializes the loop counter N (step S121). Subsequently, distance Dmr(N) between the N-th pattern Kmr(N) from the head of the pattern group 73Kr and the N-th pattern Cmr(N) from the head of the pattern group 73Cr is obtained by measurement. Then, the deviation with respect to the reference value is obtained. (step S123). Here, the reference value is a value obtained by subtracting deviation Dc_subC in the sub-scanning direction from the interval P1. The controlling unit 60 repeats the processing of step S123 until the loop counter N reaches 17 (steps S125, S129). Thus, each deviation of Cmr(1) to Cmr(17) is obtained. Then, deviation Dc_mnrC on the main scanning starting end side is obtained as the average of each deviation of the obtained Cmr(1) to Cmr(17) (step S127). By obtaining the average of the Cmf(1) to Cmf(17), the disturbance due to eccentricity of the photoconductor drum 10C is suppressed.

As for magenta also, in the same procedure, the controlling unit 60 obtains deviation Dc_mnrM on the main scanning starting end side by using pattern groups 73Kr and 73Mr. As for yellow also, in the same procedure, deviation Dc_mnrY on the main scanning starting end side is obtained, by using pattern groups 73Kr and 73Yr.

Subsequently, based on the difference between the deviation Dc_mnrC of cyan on the main scanning terminate end side and the deviation Dc_mnfC of cyan on the main scanning starting end side, the adjustment amount of the main scanning magnification of cyan is obtained. Also, based on the difference between the deviation Dc_mnrM of magenta on the main scanning terminate end side and the deviation Dc_mnfM of magenta on the main scanning starting end side, the adjustment amount of the main scanning magnification of magenta is obtained. Still further, based on the difference between the deviation Dc_mnrY of yellow on the main scanning terminate end side and the deviation Dc_mnfY of yellow on the main scanning starting end side, the adjustment amount of the main scanning magnification of yellow is obtained.

### (Overall Processing Procedure)

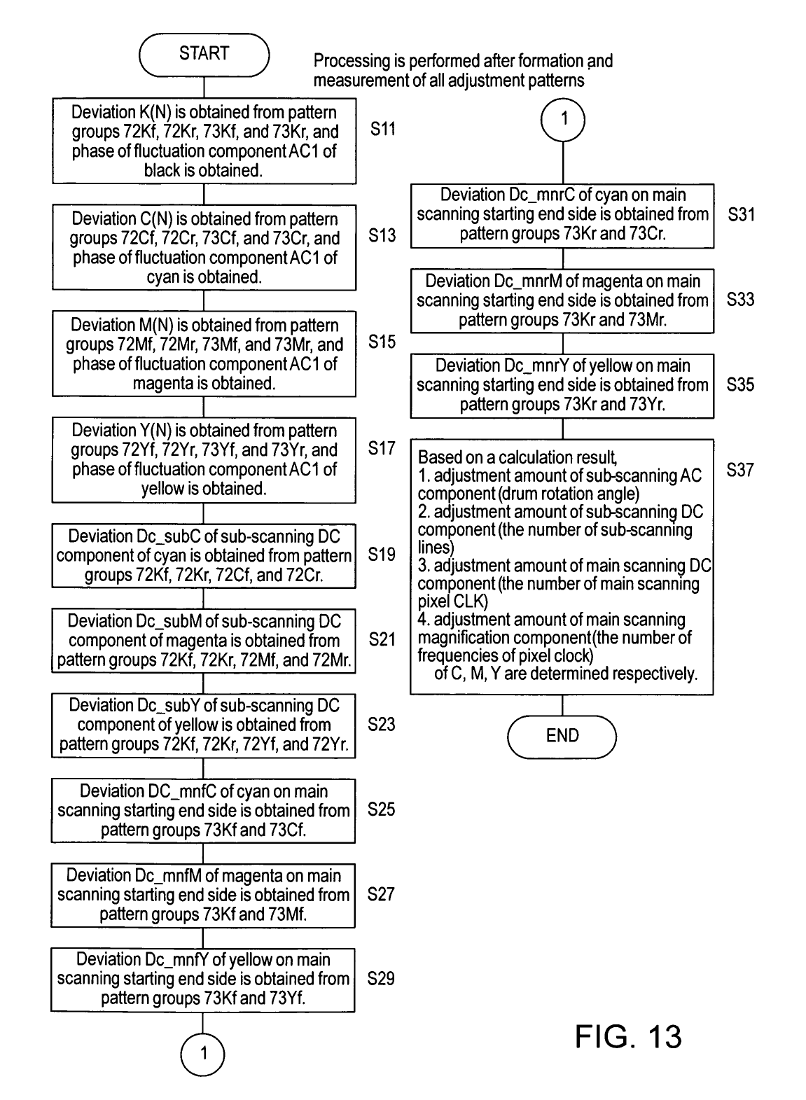

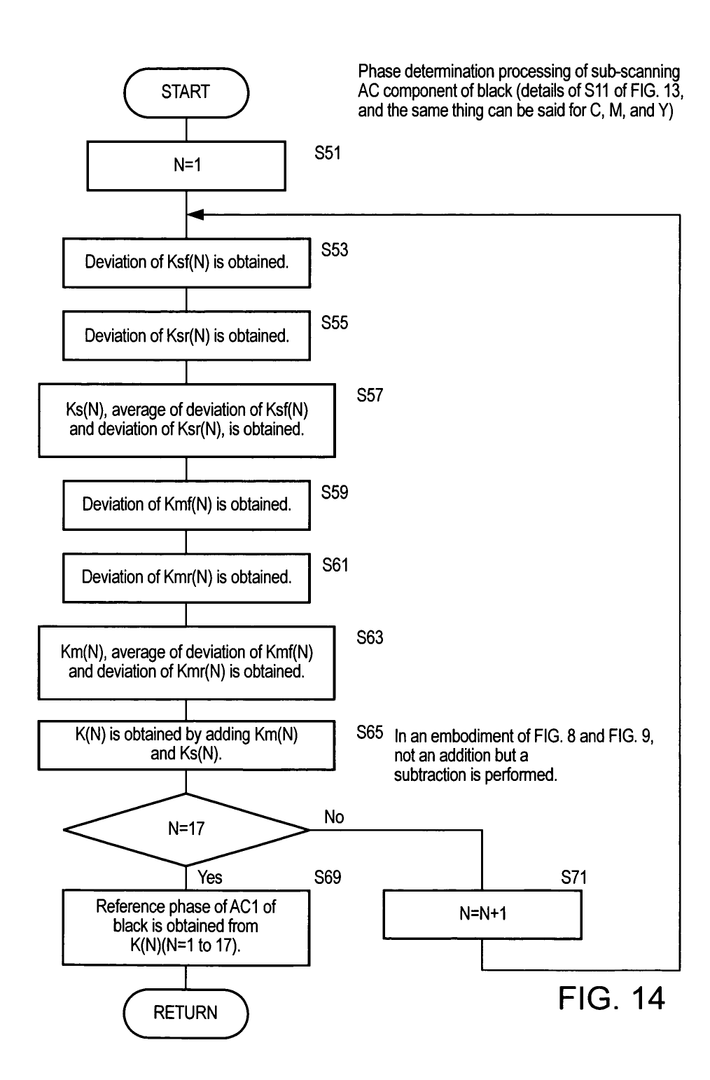

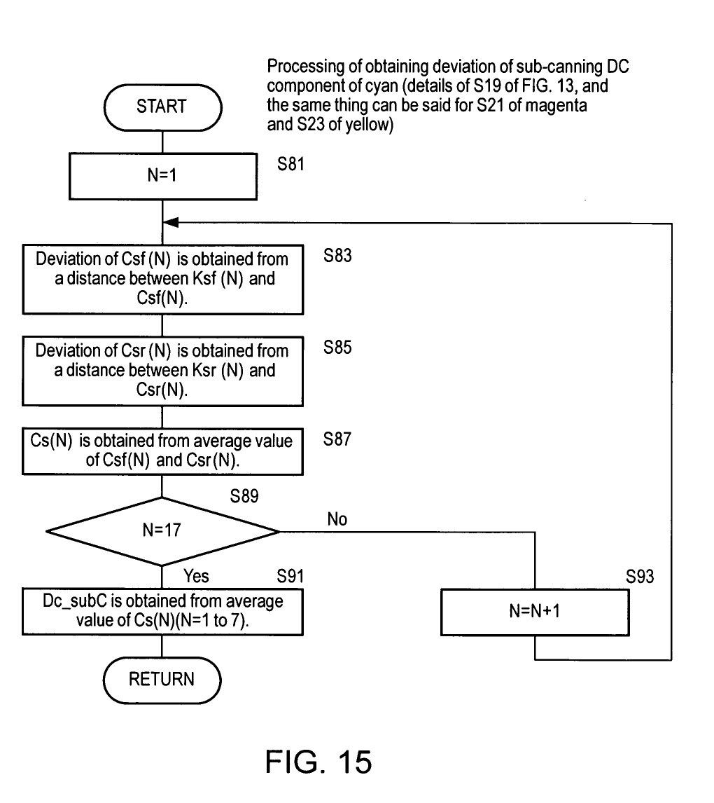

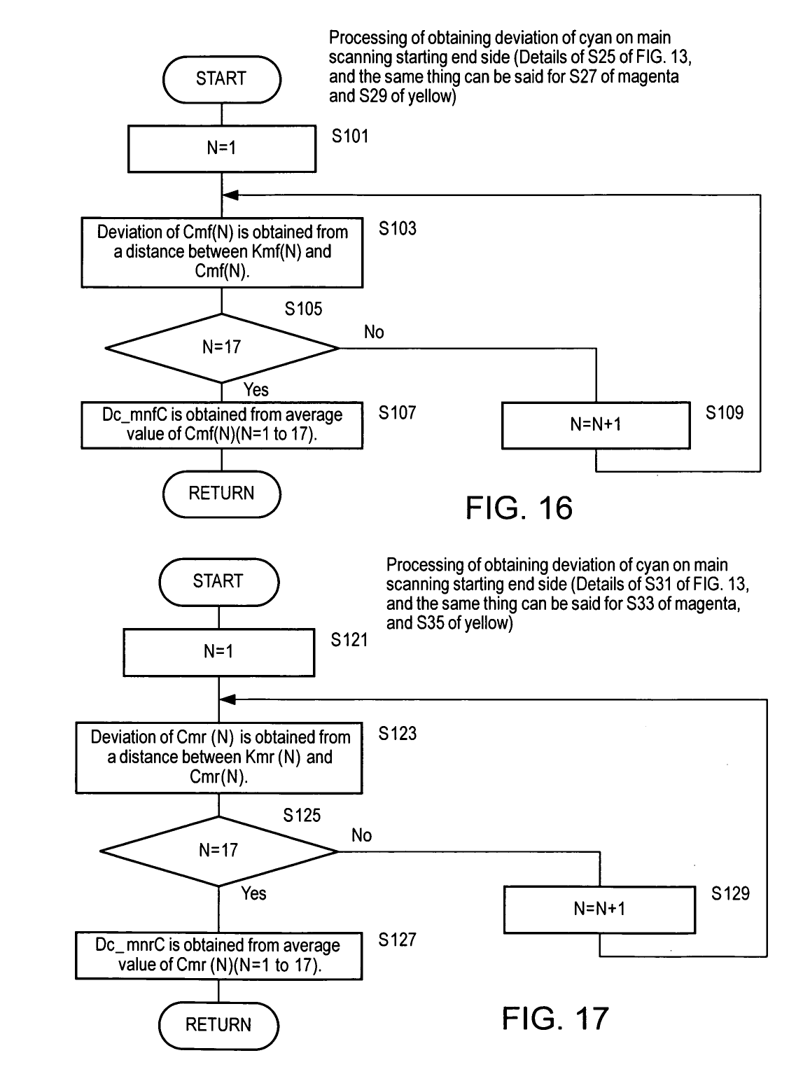

FIG. 13 is a flowchart showing an overall procedure for determining the adjustment amount of each element of the color misregistration. The procedure will be explained along the flowchart of FIG. 13. Note that the processing of FIG. 13 is performed after the measurement of each pattern is finished.

First, the controlling unit 60 calculates the deviation related to the sub-scanning AC component. First, as for black, deviation K(N) is obtained from pattern groups 72Kf, 72Kr, 73Kf, 73Kr, and a reference phase of the fluctuation component AC1 of black is obtained (step S11). Details are shown in FIG. 14. Similarly, the reference phase of the fluctuation component AC1 of each of the cyan (step S13), magenta (step S15), and yellow (step S17) is obtained.

Subsequently, the controlling unit 60 calculates the deviation related to the sub-scanning DC component, with black as a reference. First, as for cyan, deviation Cs(N) is obtained from pattern groups 72Kf, 72Kr, 72Cf, 72Cr, and deviation Dc_subC of the sub-scanning DC component of cyan is obtained (step S19). Details are shown in FIG. 15. Similarly, deviation Dc_subM of the sub-scanning DC component of magenta is obtained from pattern groups 72Kf, 72Kr, 72Mf, and 72Mr (step S21), and further deviation Dc_subY of the sub-scanning DC component of yellow is obtained from pattern groups 72Kf, 72Kr, 72Yf, and 72Yr (step S23).

Further subsequently, the controlling unit 60 calculates the deviation on the main scanning starting end side, with black as a reference. First, as for cyan, deviation Dc_mnfC of cyan on the main scanning starting end side is obtained from pattern groups 73Kf and 73Cf (step S25). Details are shown in FIG. 16. Similarly, deviation Dc_mnfM of magenta at the main scanning starting end side is obtained from pattern groups 73Kf and 73Mf (step S27), and further deviation Dc_mnfY of yellow on the main scanning starting end side is obtained from pattern groups 73Kf and 73Yf (step S29).

Next, the controlling unit 60 calculates the deviation on the main scanning terminate end side, with black as a reference. First, as for cyan, deviation Dc_mnrC of cyan on the main scanning terminate end side is obtained from pattern groups 73Kr and 73Cr (step S231). Details are shown in FIG. 17. Similarly, deviation Dc_mnrM of magenta on the main scanning terminate end side is obtained from pattern groups 73Kr and 73Mr (step S27), and further deviation Dc_mnrY of yellow on the main scanning terminate end side is obtained from pattern groups 73Kr and 73Yr (step S35).

Then, the controlling unit 60 determines the adjustment amount based on each deviation thus obtained. Namely, an adjustment angle of each rotating phase of the photoconductor drums 10C, 10M, and 10Y is determined based on the sub-scanning AC component. In addition, the adjustment amount (the number of the sub-scanning lines) of the writing start timing of the sub-scanning DC component of cyan, magenta, and yellow in the sub-scanning direction is determined. Further, as for the sub-scanning DC component, the adjustment amount (the number of pixel clocks) of the writing start timing of cyan, magenta, yellow in the main scanning direction is determined. As for the main scanning magnification component, the adjustment amount (the number of pixel clock frequencies) of the magnification of cyan, magenta, and yellow is respectively determined (step S37). In the image formation thereafter, the image is formed based on the determined adjustment amount.

### (Detailed Explanation for the Adjustment of the Rotating Phase)

Detailed explanation will be further given hereunder for the adjustment of the rotating phase of the photoconductor drum, for the purpose of a suppression of the sub-scanning AC component, being the first element of the color misregistration.

The image formed by each photoconductor in different colors includes the pitch fluctuation component due to eccentricity of each photoconductor. When there is a mismatch in this pitch fluctuation, this is recognized as the color misregistration of the image.

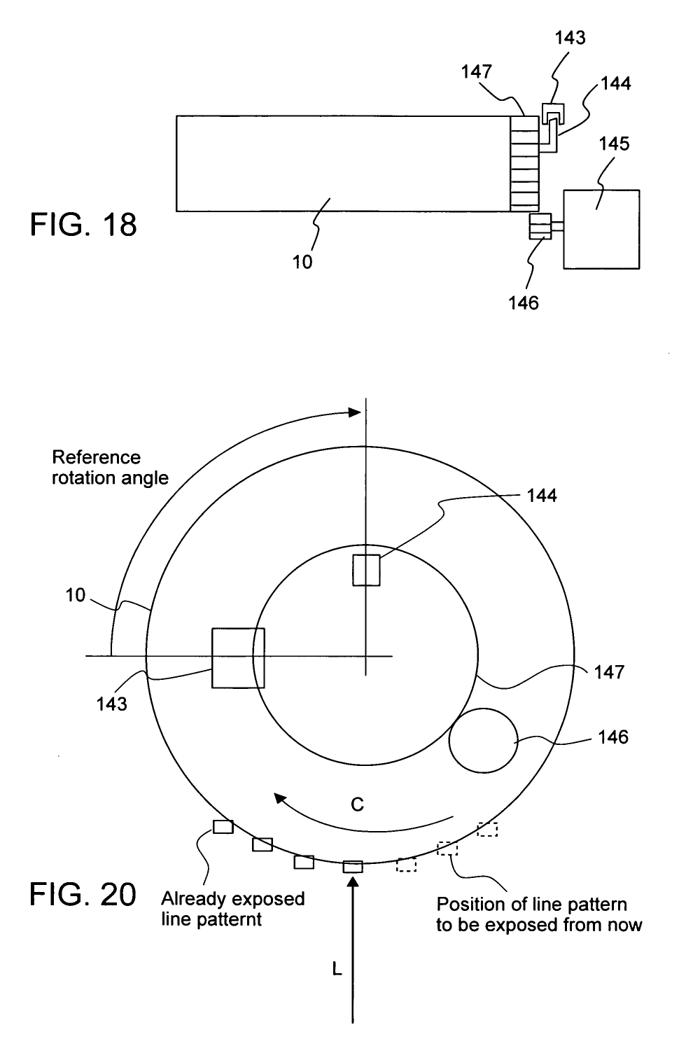

FIG. 18 is an explanatory view showing the photoconductor drum 10 and a drive mechanism of a photoconductor drive motor 145 for driving the photoconductor drum 10. FIG. 18 is a side view showing the photoconductor drum 10 and the photoconductor drive motor 145 viewed from a direction orthogonal to a rotating shaft of the photoconductor drum 10. A driven gear 147 is provided integrally with a flange of the photoconductor drum 10 on one end side of the photoconductor drum 10.

Each photoconductor drum 10 is driven by the photoconductor drive motor 145 corresponding to this photoconductor drum. A rotation of the drive motor 145 is controlled by the controlling unit. A drive gear 146 is engaged with an output shaft of the photoconductor drive motor 145. The drive gear 146 is fitted into the aforementioned driven gear 147.

As shown in FIG. 18, a phase sensor 143 generating a reference signal for controlling the rotating phase is disposed, so as to correspond to each photoconductor drum 10. A protrusion 144 is disposed on the side of the photoconductor drum 10. The phase sensor 143 outputs the reference signal every time the photoconductor drum 10 rotates once and the protrusion 144 passes through a detection part. For example, a photo interrupter can be used as the phase sensor 143. Each reference signal is inputted in the controlling unit 60. The controlling unit 60 adjusts the phase of each photoconductor by using the inputted reference signal, and controls a drive of each photoconductor drive motor 145.

A quantitative relation of the pitch fluctuation and the deviation amount will be explained. When a peripheral speed at an exposure position is higher than a reference speed, the deviation is generated in a positive direction in FIG. 5, as the pitch fluctuation component. Thereafter, the peripheral speed is decreased to the reference speed. However, the deviation in the positive direction generated heretofore is not reduced, unless the peripheral speed is set further lower than the reference speed. Accordingly, when the peripheral speed is decreased to the reference speed, the deviation still remains in the positive direction. Thereafter, when the photoconductor speed is lower than the reference speed, the deviation is generated in a negative direction. Then, the deviation in the positive direction is offset soon.

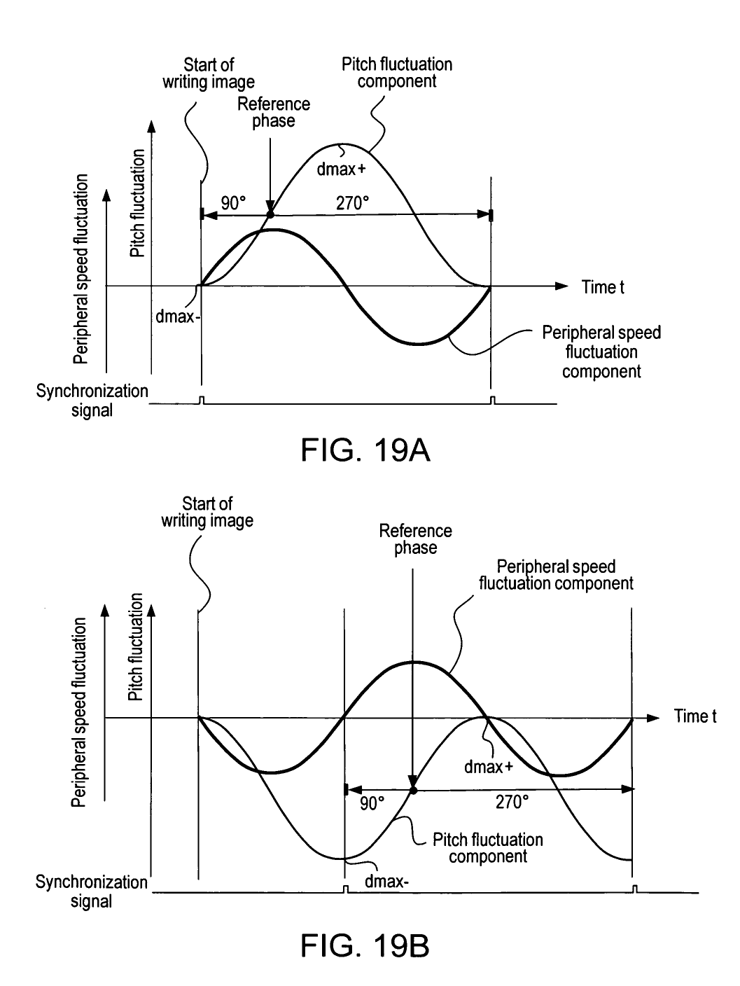

This relation is shown in a waveform chart of FIG. 19. The phase of a peripheral speed fluctuation component of the photoconductor is recorded as an image at the time of exposure. There is a time difference of a moving time between an exposure and a detection of the deviation, such as the moving time of an exposure position→a transfer position→the photo sensor 34. Namely, there is a time corresponding to (½ of the photoconductor peripheral length+distance from the transfer position to the photo sensor 34)÷process speed. For example, when the K photoconductor is cited as an example, (30 π/2+280)÷173=1.89 (sec) is established. Note that as shown in FIG. 3, this time difference is different in each photoconductor. In FIG. 19, a graph of the pitch fluctuation component is traced back by the aforementioned time difference and overlapped on the graph of the peripheral speed fluctuation component. Time t is taken on the horizontal axis of FIG. 19. The peripheral speed fluctuation component at each time and a fluctuation of the deviation amount (pitch fluctuation component) caused by the peripheral speed fluctuation component is taken on the vertical axis.

FIG. 19A shows a case that the photoconductor speed is increased from the writing start time of the image and is decreased thereafter. FIG. 19B shows a case that the photoconductor speed is decreased from the writing start time of the image and is increased thereafter.

By performing the aforementioned measurement for each color, the controlling unit obtains the pitch fluctuation component of each photoconductor drum 10 when the toner pattern of each color is formed.

### (A Determination Method of the Adjustment Amount of the Rotating Phase of the Photoconductor Drum)

A reference rotation angle will be explained. FIG. 20 is an explanatory view showing a condition in which the toner pattern for adjustment is formed on the photoconductor drum 10. The electrostatic latent image is formed on the photoconductor drum 10, at the position for scanning and exposing the photoconductor by laser beam L. Now, in FIG. 20, when the position on the photoconductor drum 10 exposed at that instant is a reference phase obtained by the measurement thereafter, an angle formed by the protrusion 144 and the phase sensor 143 is defined as a “reference rotation angle”. The rotation angle of the photoconductor drum 10 is an angle formed after the protrusion 144 passes through the phase sensor 143. The reference rotation angle corresponds to the rotation angle formed after the phase sensor 143 outputs the reference signal just before, until the toner pattern, being the reference phase, is exposed.

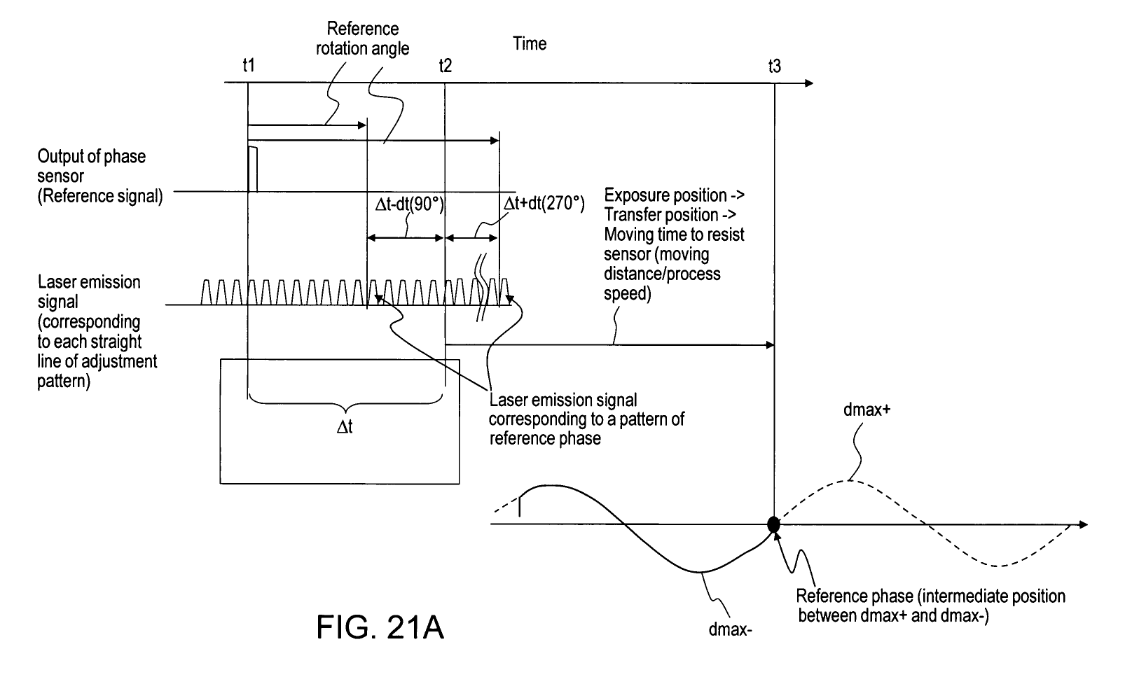

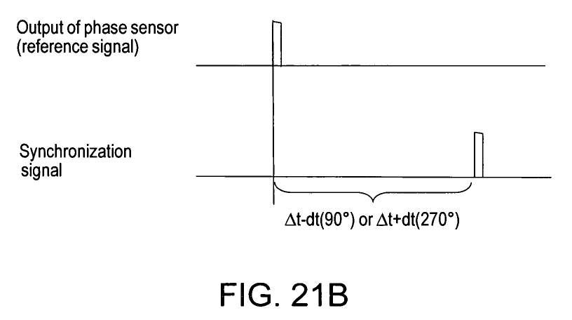

FIG. 21 is an explanatory view for explaining a relation between the reference rotation angle and the reference phase related to FIG. 20. In FIG. 21, a horizontal direction shows an elapsing of time. A laser emission signal is a signal for driving a laser irradiating part, so that the laser beam L is emitted for writing an adjustment toner pattern in the photoconductor, corresponding to each laser emission signal. The aforementioned reference clock is generated after generation time of each laser emission signal (moving time of exposure position→transfer position→photo sensor 34). As shown in FIG. 2A, the protrusion 144 passes through the phase sensor 143 at time t1, and the reference signal is outputted. Thereafter, the position, being the reference phase, is exposed at time t2, and the electrostatic latent image of the toner pattern for adjustment is formed at this position. The time from t1 to t2 is represented by Δt. The pattern of a part corresponding to the reference phase is developed along with the rotation of the photoconductor drum 10 to form the toner image, and thereafter reaches the transfer position. The toner image is transferred to the intermediate transfer belt 30 at the transfer position. The transferred toner image is read by the photo sensor 34 at time t3. The controlling unit obtains the reference phase from the deviation amount of the toner pattern thus read. Consequently, the pattern read by the photo sensor 34 at time t3 is the position corresponding to the reference phase. Δt is obtained as follows.

Δt=(time from t1 to t3)−(moving time of exposure position→transfer position→photo sensor 34)

As described above, there is a phase difference corresponding to a photoconductor rotation angle of 90° between the phase of the pitch fluctuation component and the phase of the peripheral speed fluctuation component. Accordingly, when a synchronization signal is created, as shown in FIG. 21B, correction of Δt is added to the reference signal and correction time dt(90°) (sec) corresponding to rotation time is subtracted from the reference signal. Alternately, the correction time dt (270°) (sec) corresponding to the time required for rotating 270° of a photoconductor rotation angle is added (see FIG. 21B). Here, dt(x) is calculated as follows.

dt(x)=R×π÷v0×x+360(°)

R: Photoconductor diameter
V0: Photoconductor peripheral speed

As described above, based on the measured reference phase of the toner pattern, the controlling unit determines the reference rotation angle of each photoconductor drum.

Further, the controlling unit adjusts the rotating phases of the photoconductor drums of Y, M, C, and K, so that mutual reference phases are aligned, from the measured deviation amount of the reference phase of the toner pattern.

Then, for example, exposure may be started so as to expose a tip end portion of a print image at the reference rotation angle of each photoconductor drum, at the time of image formation of the print image based on the image data generated by reading the document or generated by an external computer. Alternately, the tip end portion of the image may be exposed so as to be delayed from the reference phase by a prescribed angle. Such an amount of delay is made equal to each other in all cases of Y, M, C, and K. Thus, the phases of the respective formed images of Y, M, C, and K are aligned with each other, so that the color misregistration is inconspicuous.

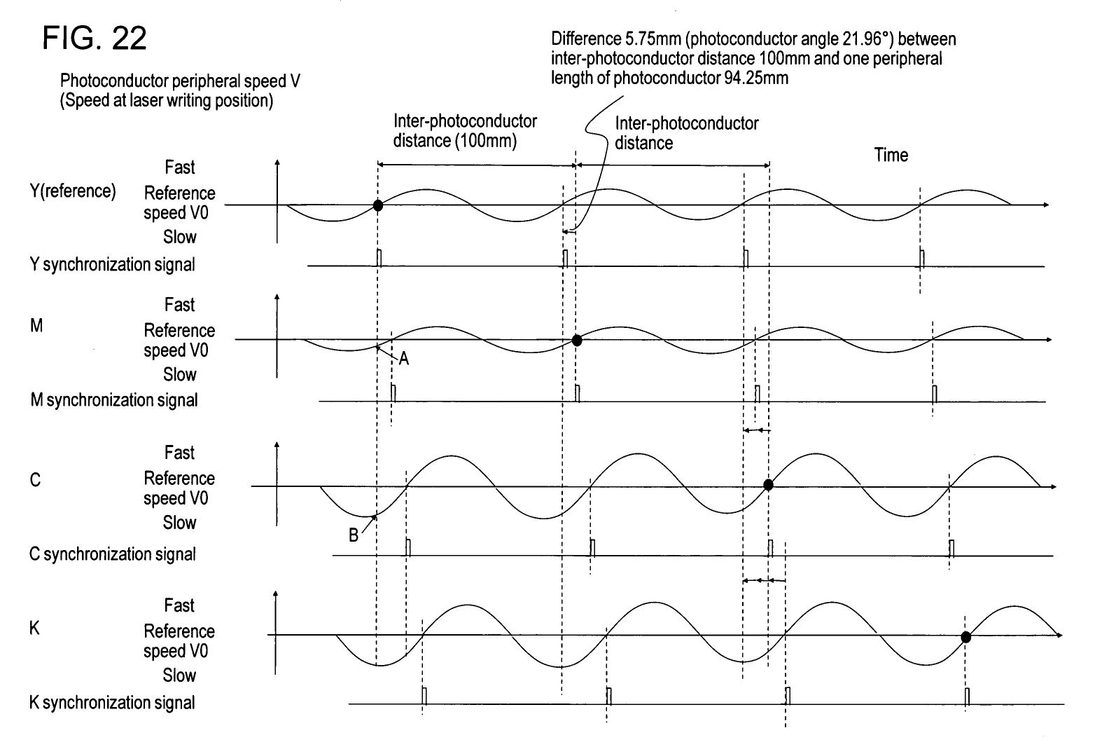

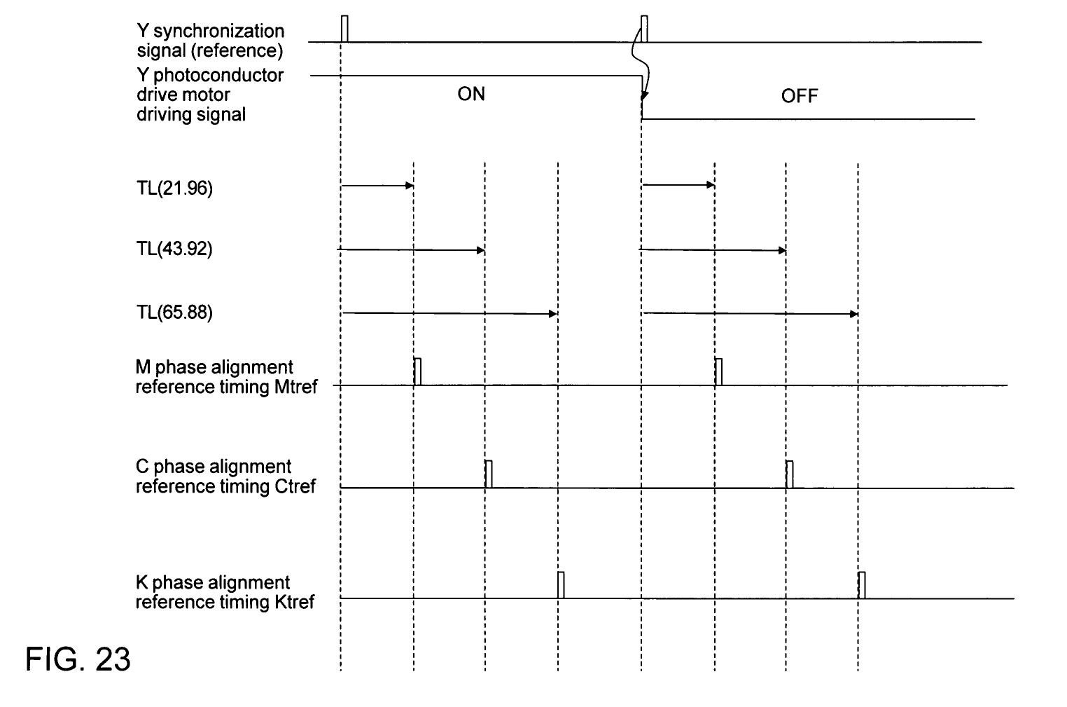

The controlling unit executes the adjustment of the rotating phase of each photoconductor drum 10, for example in a case that formation of the toner pattern is finished and each photoconductor drum 10 is stopped. At the time of stopping each photoconductor drum, the rotation of each photoconductor drive motor 145 is controlled, so that the rotation angle is set in a prescribed relation, with each photoconductor drum 10 stopped. Namely, the rotation angle of each photoconductor drum 10 at the time of stopping this photoconductor drum is controlled, so that the synchronization signal of YMCK is set in a prescribed phase relation shown in FIG. 22.

FIG. 22 is an explanatory view showing the peripheral speed fluctuation component, with the rotating phase of each photoconductor adjusted to align the phases of the pitch fluctuation components on the image. A black circle “” in FIG. 22 shows the position of each image of Y, M, and C to be transferred to the same position on a recording medium. At this time, the reference phase of the photoconductor drum 10 of each color of Y, M, C, and K, is deviated from each other. The distance between transfer positions of the photoconductor drum 10Y and the photoconductor drum 10M is 100 mm. Meanwhile, the peripheral length of the photoconductor drum 10 is 92.25 mm. Accordingly, there is a deviation between both photoconductor drums by 5.75 mm in distance and 21.96° in photoconductor rotation angle. The same thing can be said for the relation between the photoconductor drum 10M and the photoconductor drum 10C, and there is the deviation of 5.75 mm in distance and 21.96° in photoconductor rotation angle.

Accordingly, the rotating phase of the photoconductor drum 10M is delayed by 21.96° from the rotating phase of the photoconductor drum 10Y in a state after adjustment. Similarly, the rotating phase of the photoconductor drum 10C is delayed by 21.96° from the rotating phase of the photoconductor drum 10M. Namely, the rotating phase of the photoconductor drum 10C is delayed by 43.92° from the rotating phase of the photoconductor drum 10Y. Similarly, the rotating phase of the photoconductor drum 10K is delayed by 21.96° from the rotating phase of the photoconductor drum 10C. Namely, the rotating phase of the photoconductor drum 10K is delayed by 65.88° from the rotating phase of the photoconductor drum 10Y.

When the distance between the respective transfer positions is made equal to the peripheral length of the photoconductor, the rotating phase of each photoconductor can be made equal to each other. In this case, a layout space in a circumference of each photoconductor and a size of the image forming apparatus are restricted.

Therefore, the phase is controlled so that each photoconductor has a prescribed phase difference shown in FIG. 22, with any one of Y, M, C, and K set as a reference. For example, rotating phase adjustment shown below is executed, so that synchronization signals of M, C, and K have delay of 21.96°, 43.92°, and 65.88°, respectively with respect to the synchronization signal of Y, for example.

### (Execution of the Rotating Phase Adjustment of the Photoconductor Drum)

Further explanation will be given for a specific technique of adjusting the rotating phase of each photoconductor drum.

As described above, the adjustment of the rotating phase is realized by controlling, so that an eccentric direction of each photoconductor drum 10 after stop is set in a prescribed direction, when the photoconductor drum 10 is stopped by the controlling unit 60. The controlling unit 60 obtains the pitch fluctuation component due to eccentricity of each photoconductor drum 10 by the measurement of the adjustment toner pattern, and outputs the synchronization signal at a timing for setting the position of the reference phase of the obtained pitch fluctuation component and the position on the photoconductor drum exposed by the laser beam L in a prescribed relation. Specifically, the synchronization signal is outputted at a timing for exposing by the laser beam L the position in a phase of −90° or +270° from the position of the reference phase as shown in FIG. 19. As shown in FIG. 22, an output timing of each synchronization signal of Y, M, C, and K is in a state of having a time interval corresponding to a prescribed photoconductor rotation angle (the aforementioned 21.96°), with the rotating phase of each photoconductor drum 10 of Y, M, C, and K adjusted. This state is called hereunder a state that the rotating phases of the photoconductor drums are aligned. In addition, the timing for outputting each synchronization signal of M, C, K, with the rotating phases of the photoconductor drums aligned, is called a reference timing Mtref, Ctref, and Ktref.

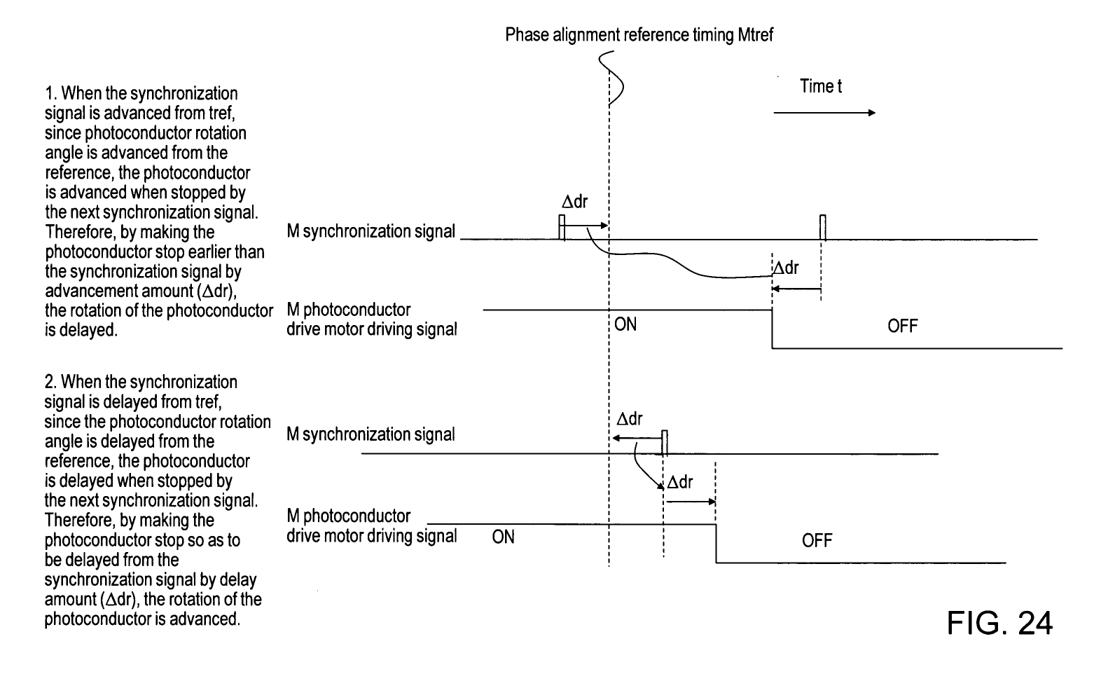

FIG. 24 is an explanatory view showing a condition of adjusting the rotating phase by the controlling unit 60 in a case that an M synchronization signal is advanced from the signal Mtref, being a reference, and in a case that the M synchronization signal is delayed from the signal Mtref. As for C and K synchronization signals also, the same adjustment as that of the M synchronization signal of FIG. 24 may be applied. Note that as described above, the reference timing here is a time when Mtref is delayed by 21.96°, Ctref is delayed by 43.92° and Ktref is delayed by 65.88°, respectively from a Y synchronization signal.

The controlling unit 60 obtains Mtref, Ctref, and Ktref, being the reference timing of a phase alignment performed to each of the photoconductor drums 10M, 10C, and 10K, from the synchronization signal of the photoconductor drum 10Y, and based on the time difference between the reference timing of each color and the synchronization signal, adjusts the rotating phase of the photoconductor drums 10M, 10C, and 10K. Note that delay time TL(x) from the Y synchronization signal, with respect to a delay amount (x°) of the phase is obtained by the following formula.

TL(x)=R×πV0×x÷360(°)

wherein R: photoconductor diameter, V0: photoconductor peripheral speed

FIG. 23 is an explanatory view showing a relation of the reference timing Mtref, Ctref, and Ktref of each color of M, C, and K with respect to the synchronization signal of the photoconductor drum 10Y.

As described above, FIG. 24 shows the condition of adjusting the rotating phase by the controlling unit 60, citing the photoconductor drum 10M as a reference. Detailed explanation therefore will be given hereunder. The controlling unit 60 monitors delay/advancement of the M synchronization signal from the Y synchronization signal before stop. Namely, an amount of advancement or an amount of delay Δdr is obtained. Thereafter, the photoconductor drum 10Y, being the reference, is stopped at a prescribed position.

FIG. 24 shows in an upper stage a case that an output of the M synchronization signal is advanced, and in a lower stage a case that the output of the M synchronization signal is delayed from the reference timing Mtref. When the rotating phase adjustment is started, first, the photoconductor drum 10Y is stopped by the controlling unit 60, with the Y synchronization signal set as a trigger. When the photoconductor drum 10M is advanced from Mtref, being the reference of stop (upper stage), the photoconductor drum 10Y is stopped earlier by Δdr than the M synchronization signal supposed to be outputted thereafter. Namely, the next synchronization signal is outputted after the time (photoconductor peripheral length÷peripheral speed) required for one rotation of the photoconductor drum after detecting the synchronization signal. Therefore, the photoconductor may be stopped after the synchronization signal is detected {(time required for one rotation of the photoconductor)−Δdr}. Thus, the advancement of the phase from Mtref is corrected. Meanwhile, when the M synchronization signal is delayed from Mtref, being the reference (lower stage), the photoconductor drum 10M is further delayed by Δdr from the M synchronization signal outputted delayed by Δdr from Mtref, being the reference of stop, and is stopped. Thus, the delay of the phase from Mtref is corrected. As for the photoconductor drums 10C and 10K also, similar control is performed to the corresponding phase alignment reference timing Ctref and Ktref.

The adjustment of the rotating phase is preferably executed every time each photoconductor drum 10 is stopped. In a process of continuously printing a plurality of pages, the rotating phase of each photoconductor is unintentionally deviated little by little in some cases. Such a deviation is considered to be caused by a slight error of a diameter of the photoconductor drum and a disturbance factor of a drive control system. By adjusting the rotating phase at the time of stopping the photoconductor drum 10, an effect of suppressing the color misregistration can be maintained.

In addition to the above-described embodiments, there are various modified examples of the present invention. A pattern group of each color arranged in the sub-scanning direction, for example, an arrangement order of 72Kf and 73Kf may be different from that of FIG. 1. Also, the arrangement order of the pattern group of each color, for example, the arrangement order of 72Kf, 72Cf, 72Mf, and 72Yf may be different from that of FIG. 1. Inclination of the patterns on the main scanning starting end side and the main scanning terminate end side may be respectively opposite directions to those of FIG. 1. Namely, mutual interval may be made narrower toward a direction shown by arrow M. In addition, a combination of such modified examples and other modified examples can also be considered. Such modified examples should not be interpreted as not belonging to the scope of the present invention. All modifications should be included in the present invention, within the scope of claims and in the meaning equivalent to the scope of the claims.

What is claimed is:

1. An image forming apparatus with an image adjusting function, comprising:
a photoconductor having a peripheral surface;
an image forming unit for forming an image on the peripheral surface and capable of forming a plurality of adjustment patterns on the peripheral surface;
an endless belt to which each adjustment pattern is transferred from the peripheral surface and which rotates in a prescribed direction in contact with the peripheral surface;
a measurement unit that measures a position of each transferred adjustment pattern on the endless belt;
a calculation unit that compares each measured position with a previously defined reference position, and obtains a deviation in a rotating direction and/or in a width direction orthogonal thereto of the endless belt, respectively; and
an adjustment unit that adjusts a position and/or a magnification of an image to be formed on the peripheral surface by the image forming unit based on each obtained deviation,
the adjustment patterns including a first oblique pattern intersecting with one straight line extending in the width direction on one end side of the endless belt and a second oblique pattern intersecting with the straight line on the other end side, with the first oblique pattern obliquely intersecting with the straight line in a right front direction and the second oblique pattern obliquely intersecting with the straight line in a left front direction,
the calculation unit obtaining the deviation in the rotating direction from an average of the deviation of the first oblique pattern in the rotating direction and the deviation of the second oblique pattern in the rotating direction and obtaining the deviations in the width direction from the deviations of the first oblique pattern in the width direction and from the deviations of the second oblique pattern in the width direction, respectively.

2. The image forming apparatus according to claim 1, wherein the first oblique pattern and the second oblique pattern obliquely intersect with the straight line at a same angle.

3. The image forming apparatus according to claim 2, wherein the first oblique pattern and the second oblique pattern obliquely intersect with the straight line at approximately 45 degrees.

4. The image forming apparatus according to claim 1, wherein
the adjustment patterns include a first oblique pattern group in which a plurality of patterns are arranged on one end side of the endless belt, and a second oblique pattern group in which patterns corresponding to each pattern of the first oblique pattern group are arranged on the other end side,
the first oblique pattern group is formed of the first oblique pattern and a pattern parallel thereto arranged in the rotating direction, and the second oblique pattern group is formed of the second oblique pattern and a pattern parallel thereto arranged in the rotating direction, and
the calculation unit obtains a plurality of average deviations in the rotating direction, each average deviation being obtained from an average of the deviations of two patterns corresponding to each other in the width direction, out of the patterns in the first oblique pattern group and the patterns in the second oblique pattern group, and based on a change of each average deviation, extracts a phase of the periodic fluctuation component corresponding to a peripheral length of the photo conductor.

5. The image forming apparatus according to claim 1, wherein
the adjustment patterns include a first oblique pattern group formed of the first oblique pattern and one or more patterns parallel thereto arranged in the rotating direction; and
the calculation unit obtains the deviations of the patterns of the first oblique pattern group in the width direction, respectively, and averages the obtained deviations to set it as the deviation in the width direction on a main scanning starting end side.

6. The image forming apparatus according to claim 1, wherein
the adjustment patterns include a second oblique pattern group formed of the second oblique pattern and one or more patterns parallel thereto arranged in the rotating direction; and
the calculation unit obtains the deviations of the patterns of the second oblique pattern group in the width direction, respectively, and averages the obtained deviations to set it as the deviation in the width direction on a main scanning terminating end side.

7. The image forming apparatus according to claim 1, wherein
the image forming unit has an input section for acquiring from the outside an image data representing the image to be formed and an adjustment patterns storage section for storing the predetermined pattern data representing the adjustment patterns.

8. The image forming apparatus according to claim 1, wherein
the image forming apparatus forms a color image made of a plurality of color components,
the photoconductor is disposed for each color component, respectively;
the endless belt is brought into contact with each photoconductor;
the measurement unit measures the adjustment pattern of each color component; and
the calculation unit recognizes a position of the adjustment pattern of a previously defined color component (reference color) as a reference and compares it with a position of the adjustment pattern of another color to obtain the deviation of a color component of a color other than the reference color.

9. The image forming apparatus according to claim 4, wherein
the adjustment patterns further include a first horizontal pattern group formed of a plurality of patterns arranged in the rotating direction, the plurality of patterns positioned on a main scanning starting end side, which is one end side of the endless belt in the width direction, and extending in the width direction;
the image forming unit forms each pattern of the first oblique pattern group and each pattern of the first horizontal pattern group corresponding thereto at a prescribed interval in the rotating direction;
the adjustment unit extracts a phase of a fluctuation component corresponding to a rotation period of the photoconductor based on the deviation of each pattern of the first oblique pattern group and the deviation of each pattern of the first horizontal pattern group; and
the prescribed interval is set so that phases of previously estimated periodic disturbance components of the first oblique pattern group and the first horizontal pattern group are opposite to each other.

10. The image forming apparatus according to claim 9, further comprising a drive roller driving the endless belt, wherein
the prescribed interval is set to be m times a peripheral length of the photoconductor and (n+½) times a peripheral length of the drive roller, when m and n are set to be integral numbers.

11. The image forming apparatus according to claim 9, further comprising a drive roller driving the endless belt, wherein
the prescribed interval is set to be (m+½) times a peripheral length of the photoconductor and n times a peripheral length of the drive roller, when m and n are set to be integral numbers.

12. An image adjusting method, comprising steps of:
forming a plurality of adjustment patterns on a peripheral surface of a photoconductor disposed in an image forming apparatus and having a peripheral surface, and transferring each adjustment pattern to a surface of an endless belt rotating in a prescribed direction in contact with the photoconductor;
measuring a position of each transferred adjustment pattern on the endless belt;
comparing each measured position with a previously defined reference position for calculation to obtain a deviation in a rotating direction and/or in a width direction orthogonal thereto of the endless belt, respectively; and
adjusting a position and/or a magnification of an image to be formed on the peripheral surface by an image forming unit based on each obtained deviation,
the adjustment patterns including a first oblique pattern intersecting with one straight line extending in the width direction on one end side of the endless belt and a second oblique pattern intersecting with the straight line on the other end side, with the first oblique pattern obliquely intersecting with the straight line in a right front direction and the second oblique pattern obliquely intersecting with the straight line in a left front direction,
the calculation step including: obtaining the deviation in the rotating direction from an average of the deviation of the first oblique pattern in the rotating direction and the deviation of the second oblique pattern in the rotating direction, and obtaining the deviations in the width direction from the deviations of the first oblique pattern in the width direction and from the deviations of the second oblique pattern in the width direction, respectively.

13. An image adjusting program causing a computer to execute the processing of:
forming a plurality of adjustment patterns on a peripheral surface of a photoconductor disposed in an image forming apparatus and having a peripheral surface, and transferring each adjustment pattern to a surface of an endless belt rotating in a prescribed direction in contact with the photoconductor;
measuring a position of each transferred adjustment pattern on the endless belt;
comparing each measured position with a previously defined reference position for calculation to obtain a deviation in a rotating direction and/or in a width direction orthogonal thereto of the endless belt, respectively; and
adjusting a position and/or a magnification of an image to be formed on the peripheral surface by an image forming unit based on each obtained deviation,
the adjustment patterns including a first oblique pattern intersecting with one straight line extending in the width direction on one end side of the endless belt and a second oblique pattern intersecting with the straight line on the other end side, with the first oblique pattern obliquely intersecting with the straight line in a right front direction and the second oblique pattern obliquely intersecting with the straight line in a left front direction,
the calculation processing including: obtaining the deviation in the rotating direction from an average of the deviation of the first oblique pattern in the rotating direction and the deviation of the second oblique pattern in the rotating direction, and obtaining the deviations in the width direction from the deviations of the first oblique pattern in the width direction and from the deviations of the second oblique pattern in the width direction, respectively.
